(19) United States
(12) Patent Application Publication
(10) Pub. No.: US 2008/0182340 A1
(43) Pub. Date: Jul. 31, 2008

(54) NON-CONTACT POSITIVE DISPENSE SOLID POWDER SAMPLING APPARATUS AND METHOD

(76) Inventor: Anthony V. Lemmo, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/020,438

(22) Filed: Jan. 25, 2008

Related U.S. Application Data
(60) Provisional application No. 60/897,688, filed on Jan. 26, 2007.

(51) Int. Cl. G01N 1/10; B01L 3/02

(52) U.S. Cl. 436/180; 422/100

(57) ABSTRACT

Novel and/or improved systems and methods for non-contact positive dispense solid powder handling and/or manipulation are provided. Some embodiments advantageously provide the ability to pick up powders at either constant displacement (e.g., known powder depth) or constant pressure (e.g., powder height independent), thereby desirably providing enhanced versatility and options. In some embodiments, motorized aspiration (e.g., allows for variable fill height) is utilized in combination with pneumatic dispense (e.g., can permit better powder ejection). Again, this desirably permits flexible and optimized operation.

### CROSS-REFERENCE TO RELATED APPLICATION(S)

This application claims the benefit of U.S. Provisional Application Ser. No. 60/897,688, filed Jan. 26, 2007, the entirety of which is hereby incorporated by reference herein.

### BACKGROUND OF THE INVENTION

1. Field of the Invention

The invention relates generally to solid handling or manipulating and, more particularly, to systems and methods of solid powder sampling or aspirating and non-contact delivery or dispensing of small amounts of dry powders or solids.

2. Description of the Related Art

There continues to be an increase in demand for the discovery, development and optimization of new materials. These new materials cover the range from polymers, adhesives, and pharmaceuticals all the way to catalysts, phosphors and semiconductors, among others.

A variety of methods and devices exist for obtaining and dispensing small amounts of liquids that have found use in a variety of applications. However, few methods and devices exist for accurately, precisely and/or efficiently manipulating small amounts of solids (e.g., powders), for example, in the milligram range or lower. In the laboratory, such small amounts of solids are often dispensed by hand using a scale. Unfortunately, such methods are not amenable to the rapid or automated manipulation of compounds, as they are tedious, time consuming, and prone to error.

This disadvantageously not only reduces process efficiency but also undesirably adds to the cost. Moreover, it is a difficult task to effectively utilize small quantities of solids, such as powders, when complex steps to precisely handle, transfer, deliver and process such small quantities are entailed.

### SUMMARY OF THE INVENTION

Certain embodiments provide novel and/or improved systems and methods for non-contact positive dispense solid powder handling and/or manipulation. Some embodiments advantageously provide the ability to pick up powders at either constant displacement (e.g., known powder depth) or constant pressure (e.g., powder height independent), thereby desirably providing enhanced versatility and options. In some embodiments, motorized aspiration (e.g., allows for variable fill height) is utilized in combination with pneumatic dispense (e.g., can permit better powder ejection). Again, this desirably permits flexible and optimized operation.

In accordance with some embodiments, a powder handling system is provided. The powder handling system generally comprises a dispense head which comprises at least one channel for sampling and delivering a powder. The channel comprises a probe that is at least partially insertable into a powder source to sample a predetermined amount of the powder and dispense the predetermined amount of the powder into or onto a target. The dispense head is configured such that it can be selectively operated such that the probe has the ability to pick up the powder in either a constant displacement mode with a known powder depth or a constant pressure mode which is substantially independent of powder height.

In some powder handling embodiments, the dispense head is moveable by a pneumatic or motor driven actuator. In some powder handling embodiments, the probe comprises a moveable plunger housed within an outer tube. In some powder handling embodiments, the powder source comprises a vial which is positioned in a holder assembly which comprises a vibration device that facilitates in settling the powder in the vial after a sampling operation. In some embodiments, this holder assembly further comprises a flexible stripper plate that facilitates in removal of any powder that may adhere to the probe outer surface during a sampling operation. In some powder handling embodiments, the probe is displaceable in a shearing, motion to facilitate removal of any excess powder extruding from a distal orifice of the probe. In some powder handling embodiments, the probe size is selectable from a range of different probe sizes. In some powder handling embodiments, the system comprises a reflective sensor. In some powder handling embodiments, the system comprises a proximity sensor. In some powder handling embodiments, the system comprises a controller. In some powder handling embodiments, the system comprises a motion control system. In some powder handling embodiments, the system can sample from a powder source containing as low as 1 milligram or less of the powder. In some powder handling embodiments, the system can dispense powder in the microgram range. In some powder handling embodiments, the powder comprises particles having a size in the range from about 5 microns (μm) to about 10 microns (μ). In some powder handling embodiments, the powder comprises particles having a size in the range from about 100 microns (μm) to about 150 microns (μm).

In accordance with some embodiments, a method of handling a powder is provided. The method generally comprises inserting a probe in a source containing a powder to be sampled and delivered to a target, and selecting between two modes of powder sampling. A first mode of the two modes comprises picking up the powder in a constant displacement mode with a known powder depth. A second mode of the two modes comprises picking up the powder in a constant pressure mode which is substantially independent of powder height. A predetermined amount of the powder is sampled by one of the first or second modes and a predetermined quantity of the powder is delivered to the target.

In some powder handling embodiments, a plunger of the probe is used to compress the powder prior to the sampling of said powder. In some embodiments, the compression force exerted by this plunger is measured. In some embodiments, this compression force is measured by a force or pressure sensor. In some powder handling embodiments, the delivery of a predetermined quantity of the powder to the target comprises pneumatically dispensing the powder. In some powder handling embodiments, the delivery of a predetermined quantity of the powder to the target comprises dispensing the powder using a motorized actuator. In some powder handling embodiments, the predetermined amount sampled and the predetermined quantity delivered are substantially the same. In some powder handling embodiments, the predetermined amount sampled is greater than the predetermined quantity delivered. In some powder handling embodiments, the mass of the powder delivered to the target is measured. In some embodiments, this mass measurement comprises using a mass balance or load cell to perform the mass measurement. In some powder handling embodiments, the mass of powder in the source is in the range from about 5 milligrams (mg) to about 50 milligrams (mg). In some powder handling embodiments, the mass of powder delivered to the target is in the range from about 100 micrograms (μg) milligrams to about 20 milligrams (mg).

Some embodiments of the invention relate to automated dispensing of small amounts of dry powder or solids. The amount delivered can vary from the order of nanograms to milligrams or more. Some embodiments are based on filling a cavity of known, but adjustable, volume, followed by positive displacement or ejection.

In some embodiments, a sample probe is used to dispense powders. A variety of different probe sizes can be provided with efficacy, as needed or desired. The sample probe, in some embodiments, comprises a generally cylindrical needle with a movable plunger. This sample probe advantageously allows for the ability to sample directly from source vessels, without the need to pre-process the powder. This is one unique feature of certain embodiments the system and it allows for use in applications where sampling from native source vessels is desired or required. Moreover, embodiments of the invention allow for sampling from sample masses which can be as low as 1 milligram or less.

This low mass sampling feature of embodiments of the invention is unmatched by most, if not all, conventional technologies used for delivering dry powders including those that rely on either mechanical means such as vibratory hoppers or on vacuum aspiration.

In some embodiments, each dispensing probe desirably has a substantially fixed diameter and a movable plunger. This movable plunger allows a fill height to be programmed. This fill height, combined with the fixed probe diameter yields a volume or cavity to be filled. Based on a particular powder's bulk density this volume will contain a specific mass of material. Clearly this mass can be changed by corresponding changes in the fill height (e.g., by moving the plunger).

Because powders have widely varying properties in terms of compressibility, cohesiveness, flowability, among others, several process procedures related to embodiments of the invention have been developed. Because the plunger, in some embodiments, is attached to an independent actuator (e.g., an electric motor drive), the ability to “compress” the powder against either the powder bed or the vessel bottom is gained. This compression advantageously allows for highly flowable and/or non-cohesive powders to be handled, and allows for enhanced powder retention within the probe, thereby desirably providing the capability of accurate solid mass and/or amount delivery. The compression also advantageously substantially prevents and/or mitigates the possibility of sample fall-out from the probe.

The extent of compression is variable by the amount of motion exerted by the plunger drive. This compression force, in some embodiments, can also be measured by a suitable means (such as a force strain gauge or a pressure sensor) in order to compress to a known and/or controlled pressure (or force).

In some embodiments, the probe or tube, the plunger the plunger actuator and the force strain gauge or pressure sensor can be generally considered to comprise a probe assembly or system for sampling and dispensing dry powders or solids.

Embodiments of the system comprises a dispense head which, in some embodiments is mounted on an independent actuator, thereby advantageously allowing substantially independent sampling heights within a powder sample. In one embodiment, the actuator comprises a motor driven actuator. In another embodiment, the actuator comprises a pneumatic actuator.

The ability to achieve independent sampling height is important because samples will typically be presented with varying powder fill heights and will need to be accordingly sampled from these varying heights.

In particular, embodiments of the pneumatic actuation, can be critical in some cases since they allow sampling to occur under a constant pressure. This sampling at constant pressure is, in some cases, important for reproducible delivery.

Without pneumatic actuation, e.g. by utilizing motor driven actuation, sampling occurs by lowering the probe into the powder to a constant displacement. As noted before, because powders have varying properties of bulk density, flowability, cohesiveness, and compressibility, sampling at a fixed displacement may not be suitable in some cases such as when working with disparate powder samples. For example, the probe will encounter varying resistance to movement when sampling from different powders. Under constant displacement the motor drive for the probe actuation will continue to drive the probe into the sample, creating an increase in pressure on the sample. This increase in pressure can result in varying packing density of the powder, and in some powder cases can create a “plug” of compressed powder than may not be easily ejected or dispensed. In other cases this varying compression or pressure might cause unpredictability in that the crystal structure of the powder can be potentially altered due to the localized increase in pressure.

In contrast, sampling with a pneumatic probe drive will result in a constant pressure sampling. The probe will drive into the powder bed either until the full stroke is achieved or until the powder bed provides enough resistance to stop the plunger motion. This yields a constant sampling pressure for all powders that is independent of the powder fill height or the powder properties themselves. This motion element can be controlled by a force or pressure sensor so that closed-loop, fixed pressure operation is achieved. Also, the “compression” sequence mentioned above, and further below, can be used here also with efficacy, as needed or desired.

Thus, depending on the application and the properties of the powders to be sampled, either the constant displacement or the constant pressure approach embodiments may be efficaciously utilized, as appropriate. Embodiments of the invention desirably provide system designs that advantageously incorporate both options, i.e., constant displacement or constant pressure, for flexible operation. This further enhances the versatility and utility of embodiments of the invention.

It is often desirable to have highly efficient sampling that maximizes the utilization of the powder sample provided. Because embodiments of the invention described herein allow for direct sampling from a vessel (as distinct from most other conventional approaches that require filling a delivery device with some fixed minimum sample quantity), a very efficient sampling scheme in terms of powder “budget” is achieved.

For example, some embodiments desirably allow the ability to work from as little 1 milligram (mg) or less of material and advantageously achieve utilization of greater than 90% of the provided sample. Of course, these specifications will vary with a given powder, but are achievable for many samples.

Some embodiments comprise or incorporate a sample vibration plate to assist in this efficient utilization of sample. In certain cases, it is often necessary or desirable to return to the same source vessel for either repeat delivery of powder or to achieve the desired delivered mass (e.g., 2 milligrams of sample by consecutive 1 milligram deliveries). After removing a sample of powder there is often a “void” or cavity created in the powder bed from the sampling process. By incorporating a vibration mechanism, the powder can advantageously be redistributed to collapse the void and therefore desirably allow for re-sampling. In addition, in some embodiments, this vibration mechanism is combined with the displacement motion described earlier and also later herein, which advantageously further facilitates or allows for near exhaustive delivery of powder from a source vessel through repeated sampling and re-distribution of powder.

Some key elements, aspects, advantages and novel features of certain embodiments of the invention include the following:

(a) Powder sampling vs. powder dispensing: This is the aspirate/dispense (A/D) versus bulk dispense analogy. Embodiments of the invention allow for powder sampling (i.e. A/D mode) rather than true powder dispensing (bulk mode). Desirably, some embodiments provide the ability to discretely sample powders from native vessels without the need to process the powder or deliver it in a specialized vessel.

(b) Low-mass sampling capability: Embodiments of the invention allow delivery of very low masses due to the sampling nature. For example, in some embodiments, effective delivery can be achieved down to the low microgram mass range and even lower. Desirably, this is lower by at least a factor of 10 to 100 relative to most conventional approaches.

(c) Low starting-mass capability: Because embodiments of the invention allow the choice or selection of an appropriate or suitable probe diameter for sampling (as well as, in some cases, utilization of appropriate vessel geometries), effective sampling can be achieved from as little as low milligram quantities of powder and even lower. Desirably, this is at least a factor of 100 better than most conventional approaches.

(d) High percentage utilization of powder sample: Through the combination of the above, in some embodiments, greater than 90% of the sample provided can be utilized in many cases. This may not always be the case because of the properties of certain powders. However, the inherent design of embodiments of the invention allow for highly efficient operation compared to competing conventional approaches.

Some embodiments advantageously provide the ability to pick up powders at either constant displacement (e.g., known powder depth) or constant pressure (e.g., powder height independent), thereby desirably providing enhanced versatility and options.

In some embodiments, motorized aspiration (e.g., allows for variable fill height) is utilized in combination with pneumatic dispense (e.g., can permit better powder ejection). Again, this desirably permits flexible and optimized operation.

Some embodiments provide a vibration source (e.g. vibrator or vibration plate) to allow vibration of the powder source receptacle(s), such as vial(s) or the like, to desirably allow the powder to settle after aspiration, to prepare for the next aspirate function at the same position in the source receptacle or vial.

In some embodiments, a shearing, sideways, generally horizontal or x-y plane motion of the probe or tip is utilized, after aspiration, to remove any excess material extruding from the tip orifice surface. This desirably improves the accuracy of the powder sampling.

Some embodiments provide a flexible stripper plate to remove any excess powder from the tip outer surface after an aspirate or sampling function. The tip can be moved through a hole in the plate which has one or more flexible surfaces to abut the tip and brush or scrape off any powder sticking to the probe outer surface. Again, this desirably improves the accuracy of the powder sampling.

For purposes of summarizing the invention, certain aspects, advantages and novel features of the invention have been described herein above. Of course, it is to be understood that not necessarily all such advantages may be achieved in accordance with any particular embodiment of the invention. Thus, the invention may be embodied or carried out in a manner that achieves or optimizes one advantage or group of advantages as taught or suggested herein without necessarily achieving other advantages as may be taught or suggested herein.

All of these embodiments are intended to be within the scope of the invention herein disclosed. These and other embodiments of the invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and some of its features and advantages, certain preferred embodiments and modifications thereof will become apparent to those skilled in the art from the detailed description herein having reference to the figures that follow, of which:

FIG. 1 is a simplified schematic view of a powder sampling and dispensing system illustrating features and advantages in accordance with certain embodiments of the invention.

FIG. 2 is a simplified perspective view of a powder sampling and dispensing head assembly (including a cover) illustrating features and advantages in accordance with certain embodiments of the invention.

FIG. 3 is a simplified side view of the powder sampling and dispensing head assembly of FIG. 2 (with the cover removed for clarity) illustrating features and advantages in accordance with certain embodiments of the invention.

FIG. 4 is a simplified front view of the powder sampling and dispensing head assembly of FIG. 2 (with the cover removed for clarity) illustrating features and advantages in accordance with certain embodiments of the invention.

FIG. 5 is a simplified sectional view along line 5-5 of FIG. 4 (with some items removed for clarity) illustrating features and advantages in accordance with certain embodiments of the invention.

FIG. 6 is a simplified perspective view of a powder sampling and dispensing head assembly (including a cover) having features and advantages in accordance with certain other embodiments of the invention.

FIG. 7 is a simplified side view of the powder sampling and dispensing head assembly of FIG. 6 (with the cover removed for clarity) illustrating features and advantages in accordance with certain embodiments of the invention.

FIG. 8 is a simplified front view of the powder sampling and dispensing head assembly of FIG. 6 (with the cover removed for clarity) illustrating features and advantages in accordance with certain embodiments of the invention.

FIG. 9 is a simplified sectional view along line 9-9 of FIG. 8 (with some items removed for clarity) illustrating features and advantages in accordance with certain embodiments of the invention.

FIG. 10 is a simplified perspective view of a powder sampling and dispensing head assembly (including a cover) having features and advantages in accordance with certain further embodiments of the invention.

FIG. 11 is a simplified front view of the powder sampling and dispensing head assembly of FIG. 10 illustrating features and advantages in accordance with certain embodiments of the invention.

FIG. 12 is a simplified side view of the powder sampling and dispensing head assembly of FIG. 10 illustrating features and advantages in accordance with certain embodiments of the invention.

FIG. 13 is a simplified side view of the powder sampling and dispensing head assembly of FIG. 10 (with the cover removed for clarity) illustrating features and advantages in accordance with certain embodiments of the invention.

FIG. 14 is a simplified perspective view of a vial holder assembly having features and advantages in accordance with certain embodiments of the invention.

FIG. 15 is a simplified side view of the vial holder assembly of FIG. 14 illustrating features and advantages in accordance with certain embodiments of the invention.

FIG. 16 is a simplified top view of the vial holder assembly of FIG. 14 illustrating features and advantages in accordance with certain embodiments of the invention.

FIG. 17 is a simplified sectional view along line 17-17 of FIG. 16 illustrating features and advantages in accordance with certain embodiments of the invention.

FIG. 18 is a simplified enlarged view along line 18-18 of FIG. 17 illustrating features and advantages in accordance with certain embodiments of the invention.

FIG. 19 is a simplified perspective view of a powder sampling and dispensing system illustrating features and advantages in accordance with certain embodiments of the invention.

FIG. 20 is a simplified perspective view of a benchtop powder sampling and dispensing system illustrating features and advantages in accordance with certain embodiments of the invention.

FIGS. 21-27 are simplified perspective views of a powder sampling and dispensing head assembly illustrating features and advantages in accordance with various embodiments of the invention.

FIGS. 28 and 29 are simplified perspective views of a multi-channel powder sampling and dispensing head assembly illustrating features and advantages in accordance with various embodiments of the invention.

FIGS. 30-33 are simplified perspective, side, front and enlarged views of a powder sampling and dispensing head assembly engaged with a powder source or vial assembly illustrating features and advantages in accordance with certain embodiments of the invention.

FIGS. 34-36 are simplified perspective views of a powder source or vial assembly illustrating features and advantages in accordance with certain embodiments of the invention.

FIGS. 37-44 are simplified pictorial views of a powder sampling and dispensing system (and some of its components), in a laboratory environment or setting, illustrating features and advantages in accordance with various embodiments of the invention.

FIG. 45 is a simplified flowchart of a powder sampling and dispensing process or method illustrating features and advantages in accordance with certain embodiments of the invention.

FIG. 46 is a simplified overview of some operational steps for sampling and delivering powders illustrating features and advantages in accordance with certain embodiments of the invention.

FIG. 47 is a simplified image of a partial target plate in which one or more powders have been dispensed illustrating features and advantages in accordance with certain embodiments of the invention.

FIG. 48 is a simplified image of example powder plugs from 3.0 mm, 2.0 mm and 1.0 mm diameter coring probes, respectively, illustrating features and advantages in accordance with certain embodiments of the invention.

FIG. 49 is a simplified image of Ibuprofen powder and a corresponding about 300 microgram powder plug illustrating features and advantages in accordance with certain embodiments of the invention.

FIG. 50 is a photographic view of five different powder handling probe sizes illustrating features and advantages in accordance with certain embodiments of the invention.

FIG. 51 is a simplified overview of a powder sampling and dispensing process or method illustrating features and advantages in accordance with certain embodiments of the invention.

FIG. 52 is a graphical representation of replicated experimental results showing delivered powder mass versus powder handling probe sizes illustrating features and advantages in accordance with certain embodiments of the invention.

FIG. 53 is a graphical representation of regression of the experimental data of FIG. 52 illustrating features and advantages in accordance with certain embodiments of the invention.

FIG. 54 is a graphical representation of experimental results showing delivered powder mass versus powder fill height (in a powder handling probe) illustrating features and advantages in accordance with certain embodiments of the invention.

FIG. 55 is a graphical representation of replicated experimental results showing delivered powder mass versus various different types of powder materials illustrating features and advantages in accordance with certain embodiments of the invention.

FIG. 56 is a graphical representation of experimental results showing average delivered powder mass versus powder bulk density for various different types of powder materials illustrating features and advantages in accordance with certain embodiments of the invention.

FIG. 57 is a photographic view comparing an target vial and the same vial with powder (about 8.06 milligram of naproxen) to highlight the powder sampling efficiency illustrating features and advantages in accordance with certain embodiments of the invention.

FIG. 58 is a photographic view of powder doses (about 160 μg of naproxen) sampled from the powder vial or tube of FIG. 57 and delivered as individual samples illustrating features and advantages in accordance with certain embodiments of the invention.

FIG. 59 is a photographic view of powder doses (about 160 μg of naproxen) sampled from the powder vial or tube of FIG. 57 and delivered as samples in wells of a 384-well target plate illustrating features and advantages in accordance with certain embodiments of the invention.

FIG. 60 is a graphical representation of experimental results showing repeatability of delivered powder mass versus dispense number (for a nominal dose of 130 μg naproxen) illustrating features and advantages in accordance with certain embodiments of the invention.

FIGS. 61-65 are respective schematic views of certain processes or methods involving: (i) salt selection; (ii) compatibility experiments; (iii, iv) solubility experiments; and (v) dosing studies having efficacy with certain embodiments of the invention.

FIG. 66 is a simplified schematic view of a liquid handling system which can be used with the disclosed powder handling systems illustrating features and advantages in accordance with certain embodiments of the invention.

FIGS. 67 and 68 are simplified schematic views of a liquid handling system which can be used with the disclosed powder handling systems illustrating features and advantages in accordance with certain embodiments of the invention.

### DETAILED DESCRIPTION OF THE PREFERRED EMBODIMENTS

The preferred embodiments of the invention described herein relate generally to solid handling or manipulating and, in particular, to systems and methods of solid powder sampling or aspirating and non-contact delivery or dispensing of small amounts of dry powders or solids.

While the description sets forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described herein.

Some embodiments provide solid powder manipulating and handling systems and methods with the advantageous ability to switch between two modes of powder sampling or aspiration depending on the particular application, powder properties and the like, with efficacy, as needed or desired.

The powder is sampled or aspirated into a tip, probe or corer of the system which also includes an inner controllably moveable plunger. In certain embodiments, the powder is sampled in a constant plunger displacement mode (e.g., known powder depth). In certain other embodiments, the powder is sampled in a constant plunger pressure mode pressure (e.g., powder height independent).

In some embodiments, disposable tips, probes or corers are provided. Thus, a particular sampling device may be used with one or more powders and then replaced with another one for different powders with efficacy, as needed or desired.

Some embodiments provide for a vibration device that advantageously allows for leveling of the powder(s) in the source receptacle (s). The vibration device can comprise a plate or the like that may be used to vibrate a holder or mount of the source receptacle(s) such as a vial holder.

One advantage provided by vibration is the ability to remove voids or the like in the powder sample and hence achieve the desirable ability to perform multiple transfers from generally the same location. In one embodiment, a vibrator motor or the like is mounted below or at about the base of a vial holder assembly. In modified embodiments, a vibrator motor or device may efficaciously be mounted at other suitable positions, as needed or desired, such as above or at about the top of the vial holder assembly.

In some embodiments, the system comprises a mass balance or the like. The mass balance can be used to accurately determine the amount of powder delivery (and/or aspiration) with efficacy, as needed or desired. In one embodiment, a load cell is mounted or positioned at a dispense plate which holds one or more powder target or dispense locations to measure, calculate or estimate the added powder mass.

Some embodiments relate to powder control in the context of how the powder is picked without elaborate and time-consuming steps to prepare the powder to be sampled, such as, preparing a powder bed. Advantageously, this provides the benefit of being able to work with “native” powders or substantially unprocessed powder beds. In some embodiments, a plunger of the probe, tip or corer assembly is used for powder compaction or compression.

In some embodiments, a septum, dividing wall or stripper membrane assembly generally comprising a flexible silicone membrane and stripper plate is provided above the powder source receptacle(s) or vials(s). Thus, after sampling, as the probe or tip is retracted from the corresponding source receptacle or vials, the flexible stripper membrane removes any powder on the tip outer surface.

Certain embodiments of the invention provide versatility in being adaptable to generally accommodate any one of numerous configurations of vessels or sources of powder that the probe can be efficaciously utilized to draw sample out of. In some embodiments, a system or probe plunger is raised and/or lowered by a stepper motor or the like to achieve efficacious powder sampling and/or delivery capabilities as needed or desired.

In some embodiments, a positive displacement powder ejection process is employed to advantageously facilitate substantially complete delivery of the aspirated or sampled powder. Accordingly, there is substantially none or minimal retained powder in the probe or tip after ejection or delivery.

Some embodiments relate to volume powder control by utilizing a motorized aspirate function and a high efficiency powder delivery function by utilizing pneumatic ejection. As indicated above and discussed further below, a pneumatic dispense and a motor aspirate or motorized vary fill height ability advantageously contributes to, in some embodiments, flexible and generally optimum operation.

In some embodiments, and as a further system enhancing feature, one or more reflective sensors are incorporated into the system to provide a check if and/or how much powder is loaded into the tip. This further insures and protects in the case that there can be improper powder loading. In certain embodiments, the reflective sensor(s) may also be used to see how much retained powder remains after a dispense operation or function.

As indicated above, and also discussed further below herein, the systems and methods embodiments of the invention provide the ability to sample from very small volumes of source material. This can advantageously provide optimal use of materials which in many cases can save on cost.

Systems in conjunction with some embodiments of the invention comprise a dispense head assembly. In one embodiment, the dispense head assembly is movable or displaceable in X, X-Y or X-Y-Z dimensions or Cartesian coordinate defined spatial axes. In modified embodiments, the dispense head assembly can be movable or displaceable in dimensions as defined by other dimensional and/or coordinate systems, including, but not limited to cylindrical, spherical, and any combinations taught or suggested herein with efficacy, as needed or desired.

In one embodiment, the dispense head assembly is movable or displaceable by pneumatic means such as a pneumatic pressure source. In another embodiment, the dispense head assembly is movable or displaceable by motorized means such as a motor-driven stepper motor. In modified embodiments, other suitable movable or displaceable devices may be efficaciously utilized, as needed or desired.

Some embodiments utilize one or more magnets to removably couple, attach or connect various system components. In some embodiments, selective dispense head assembly components including an optional cover are coupled, attached or connected using one or more magnets. In some embodiments, selective components of a powder vial holder assembly are coupled, attached or connected using one or more magnets.

In some embodiments, the sampling tip, probe or corer is moved in a generally x-y plane while it is in the powder which is being picked up or aspirated to shear off or remove any excess powder material extruding from the tip orifice. Advantageously, this provides a more accurate sampling and consequently delivery of the powder.

Embodiments of the invention can be efficaciously utilized to sample and deliver powders comprising a wide range of sizes and size distributions. In one embodiment, the powder comprises particle having sizes, diameters or effective diameters in the range from about 5 microns (μm) to about 10 microns (μm), including all values and sub-ranges therebetween. In another embodiment, the powder comprises particle having sizes, diameters or effective diameters in the range from about 100 microns (μm) to about 150 microns (μm), including all values and sub-ranges therebetween. In modified embodiments, the powder may comprise particle having larger or smaller sizes, diameters or effective diameters with efficacy, as needed or desired.

One advantage of systems, apparatuses or machines in accordance with embodiments of the invention is that they can effectively and accurately operate substantially independently of the powder bulk or tap density. Without being bound to any particular definition, one definition of bulk or tap powder density is the density obtained from filling a container with the sample material and vibrating it to obtain near optimum packing—tap density is not an inherent property of a material but depends on particle size distribution, measurement techniques and/or interparticle voids.

In one embodiment, the powder bulk or tap density is in the range from about 0.03 to about 4 including all values and sub-ranges therebetween. In modified embodiments, the powder bulk or tap density may be larger or smaller with efficacy, as needed or desired. The powder packing may also be generally defined in terms of void fraction.

Some embodiments relate to powder sampling and dispense techniques in combination with liquid aspirate and/or dispense functions. Advantageously, this versatility allows for a broad range of applications which involve the handling and manipulation of solids and liquids (e.g., chemical and biological reagents).

U.S. Patent Application Publication No. US 2004/0146434 A1 discloses certain systems and methods of manipulating small amounts of solids. The entirety of this patent document is hereby incorporated by reference herein and is considered a part of the present patent specification/application.

In some embodiments, to dispense liquid or reagent drops down to the nanoliter, and in some cases in the picoliter, range a technology and product base as available from BioDot, Inc. of Irvine, Calif., U.S.A. is utilized to deliver liquids or reagents. In brief, the BioDot dispensing (and/or aspirating) system in accordance with some embodiments, comprises a positive displacement syringe pump or device (or a direct current fluid source) hydraulically coupled or in fluid communication with a solenoid dispenser or actuator, and motion control means or device(s) to provide relative motion between the dispensing/aspirating tip and the target(s)/source(s), as needed or desired.

BioDot's U.S. Pat. Nos. 5,738,728, 5,741,554, 5,743,960, 5,916,524, 6,537,505 B1, 6,576,295 B2, RE38,281 E, U.S. Patent Application Publication Nos. US 2003/0211620 A1, US 2004/0072364 A1, US 2004/0072365 A1, US 2004/0219688 A1, US 2005/0056713 A1, US 2006/0211132 A1, and European Patent No. EP 1 485 204 B1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application.

U.S. Pat. Nos. 6,063,339, 6,551,557 B1, 6,589,791 B1, and U.S. Patent Application Publication Nos. US 2002/0064482 A1, US 2003/0207464 A1, US 2003/0215957 A1, US 2003/0228241 A1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application.

In some embodiments, the system comprises limit switches and/or stops to control the motion of various system components. These can include motion control of the tip, probe or corer assembly and the dispense head assembly with efficacy, as needed or desired.

Some embodiments are specially configured with a predetermined arrangement of a probe barrel which is within a mount portion to facilitate access of the tip tube into the source receptacle or vial. Alternatively, in some embodiments, the probe barrel may be dimensioned so that it may also have the ability to enter the vial. Features such as the receptacle size would play a factor in this case and the probe assembly can accordingly be efficaciously dimensioned to achieve optimum operational capabilities, as needed or desired.

In some embodiments, the system comprises a multi-channel arrangement or configuration with a plurality of sampling and dispensing tips, probes or corers. In some embodiments, the plurality of tips can efficaciously comprise different size tips with efficacy depending on the particular application, as needed or desired. In certain embodiments, a manifold may be utilized which can be in selective fluid communication with one or more of the tips, as needed or desired.

### System Overview

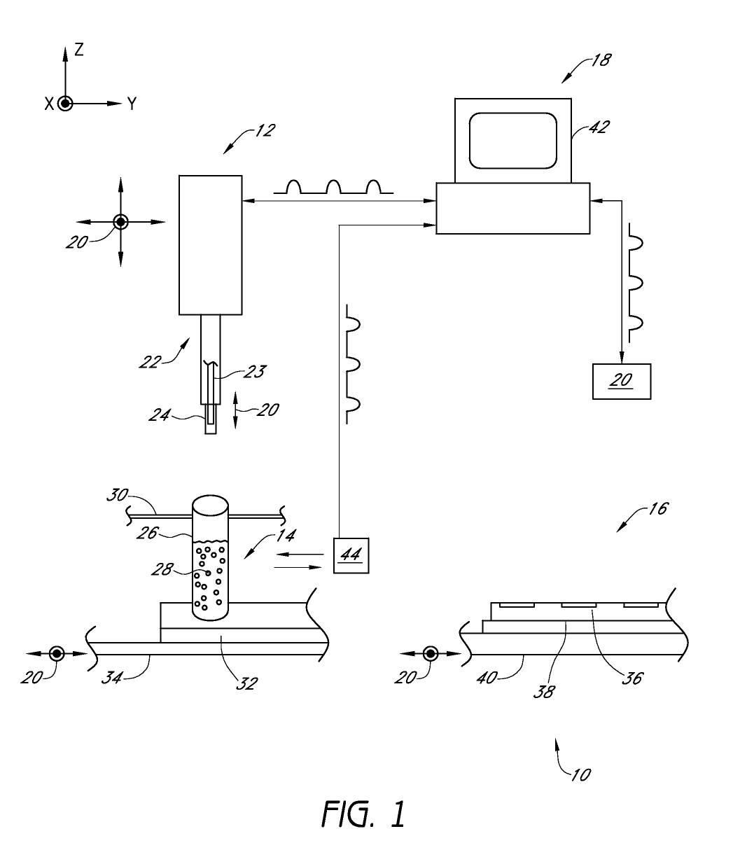

FIG. 1 shows a schematic view of certain embodiments of a powder sampling and dispensing system 10. The powder handling or manipulating system or apparatus 10 generally comprises a dispenser or dispense (and/or aspirate) head assembly, system or apparatus 12, a solid powder source assembly, system or apparatus 14, a solid target assembly, system or apparatus 16, a controller or control system, assembly or apparatus 18, and a motion control assembly, system or apparatus 20 for providing relative motion between various system components as and when needed or desired. The directional arrows in FIG. 1 are schematically used to denote the relative displacement provided by motion control system 20, which is desirably interfaced with the control system 18, and can comprise conveyor belts, moveable platforms or the like and robotic arms and the like, efficaciously actuated by motorized and/or pneumatic devices, as needed or desired.

The dispense head assembly 12 in accordance with certain embodiments generally comprises a probe assembly, system or apparatus 22 which comprises an adjustable plunger 23 slidably (or axially e.g., in the Z-direction) movable within an inner bore of the probe, tip or corer 24 for powder sampling and dispensing. As discussed further herein, the sampling in some embodiments is pneumatically actuated (e.g., at constant pressure) while in some embodiments it is motorized (e.g., constant displacement). Systems in accordance with certain embodiments can desirably provide both these capabilities and the ability to change between these sampling modes, with efficacy, as needed or desired.

In some embodiments, the plunger 23 comprises a solid generally cylindrical rod which is moveable back and forth within a generally cylindrical bore or lumen of the probe 24. The spacing between the plunger rod and the probe bore can efficaciously comprise a generally close tolerance fit, as needed or desired. In some embodiments, the plunger 23 can be considered as comprising a part of the probe 24. In other embodiments, the plunger 23 can be an independent component or comprise a part of the probe assembly 22.

Also, as discussed further herein, powder sampling and dispensing systems in accordance with certain embodiments can efficaciously be provided with different sizes of probes, tips or corers 24 (and/or probe assemblies 22), as needed or desired, depending at least on the particular application. In some embodiments, multi-channel systems with a plurality of samplers/dispensers or sample/dispense channels are utilized. The probe size can efficaciously be varied for the plurality of sample/dispense channels of a system. In some embodiments, disposable probes 24 (and/or probe assemblies 22) are employed.

The powder source assembly 14 in accordance with certain embodiments generally comprises at least one or a plurality of powder sources or vials 26 containing one or more solid powders 28 of interest, and a vial holder 30 or the like. In some embodiments, the powder source assembly 14 comprises a vibrator, vibration plate, device or mechanism 32 to advantageously facilitate settling of the powder 28 after a sampling function or operation.

As discussed further herein, in certain embodiments, the powder source assembly 14 (and/or the holder 30) comprises a flexible stripper plate or the like to facilitate removal of any excess powder that may adhere to the tip outer surface after a function or operation is performed and the tip 24 is withdrawn from the powder source or vial 26. The powder source assembly 14, in some embodiments, is seated on a conveyor belt or movable platform 34 or the like of the motion control system 20.

The powder target assembly 16 in accordance with certain embodiments generally comprises at least one or a plurality of targets 36, such as, but not limited to microtiter plates and/or vials, in which the sampled powder is accurately and precisely dispensed. In some embodiments, the target assembly 16 comprises a mass balance 38 or the like to determine or compute the mass added to the target 36. (A similar mass balance arrangement can also be provided in conjunction with powder source assembly 14 with efficacy, as needed or desired). The target assembly 16, in some embodiments, is seated on a conveyor belt or movable platform 40 or the like of the motion control system 20.

The control system 18 in accordance with certain embodiments comprises a central controller, computer or CPU 42 and facilitates in monitoring and controlling the various system operations. The control system 18 comprises suitable software and hardware to achieve these measurement, computational and diagnostic supervisory functions and operational controls.

The control system 18 is interfaced with the dispense head assembly 12 to control and coordinate sampling, dispensing and motion operations, the powder source assembly 14 to control and coordinate motion and vibratory operations, the powder target assembly 16 to control and coordinate motion and mass measurement operations, and the motion control system 20 to control and coordinate the relative motion between various system components, among other system operations, as needed or desired.

The powder sampling and dispensing system 10 in accordance with certain embodiments comprises one or more reflective sensors 44 to facilitate in checking if and/or how much powder 28 is loaded into the tip 24. In some embodiments, suitable reflective sensor(s) may also be efficaciously used to determine or compute how much retained powder remains in the tip 24 after a dispense operation or function, as needed or desired.

### Features of Certain Embodiments

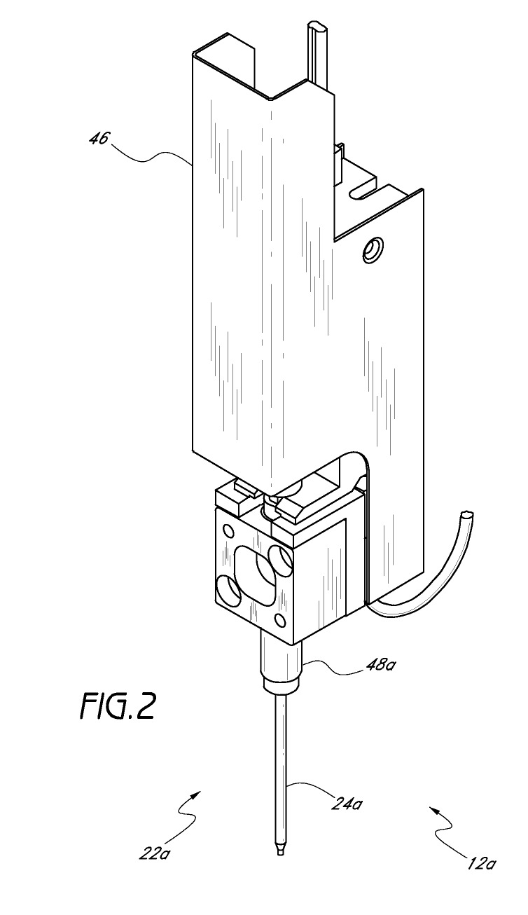

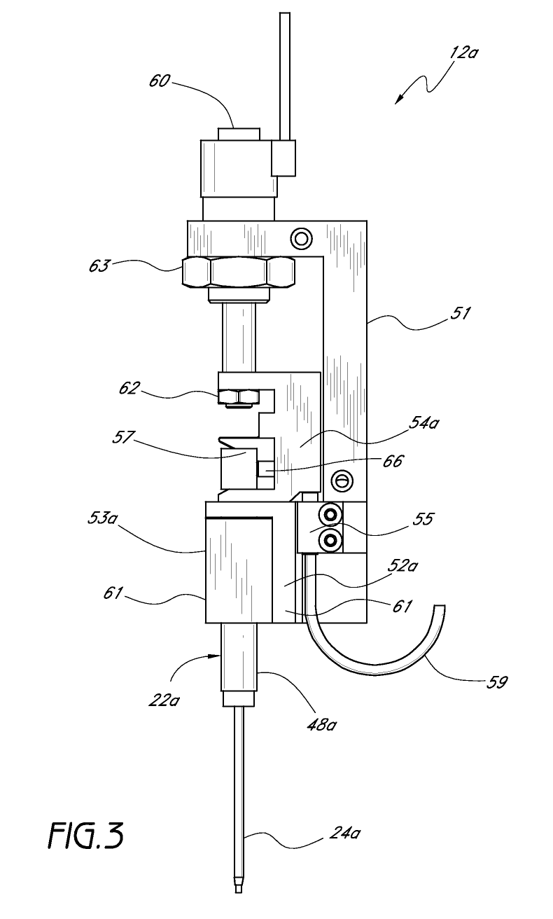

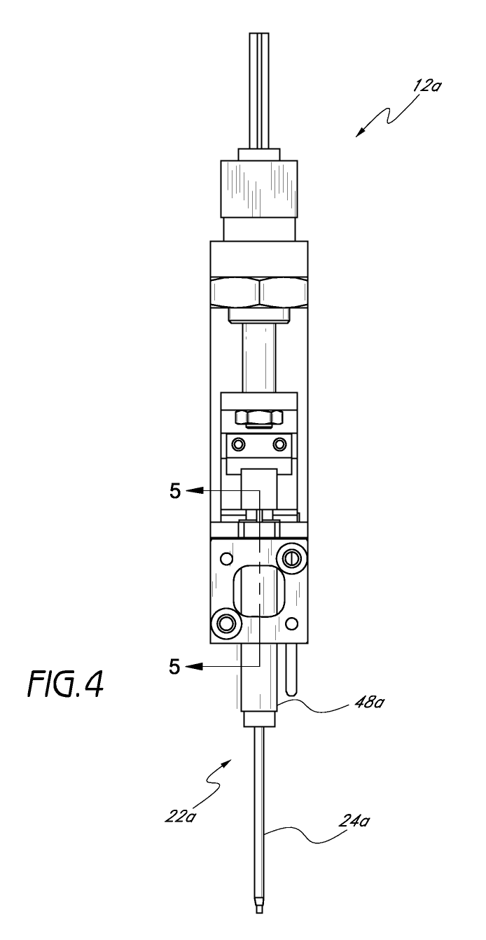

FIGS. 2-5 show different views of certain embodiments of a powder sampling and dispensing head assembly 12a. In some embodiments, and as shown in FIG. 2, the dispense head assembly 12a comprises a cover 46 or the like. The cover 46 may be removable and/or replaceable, as needed or desired.

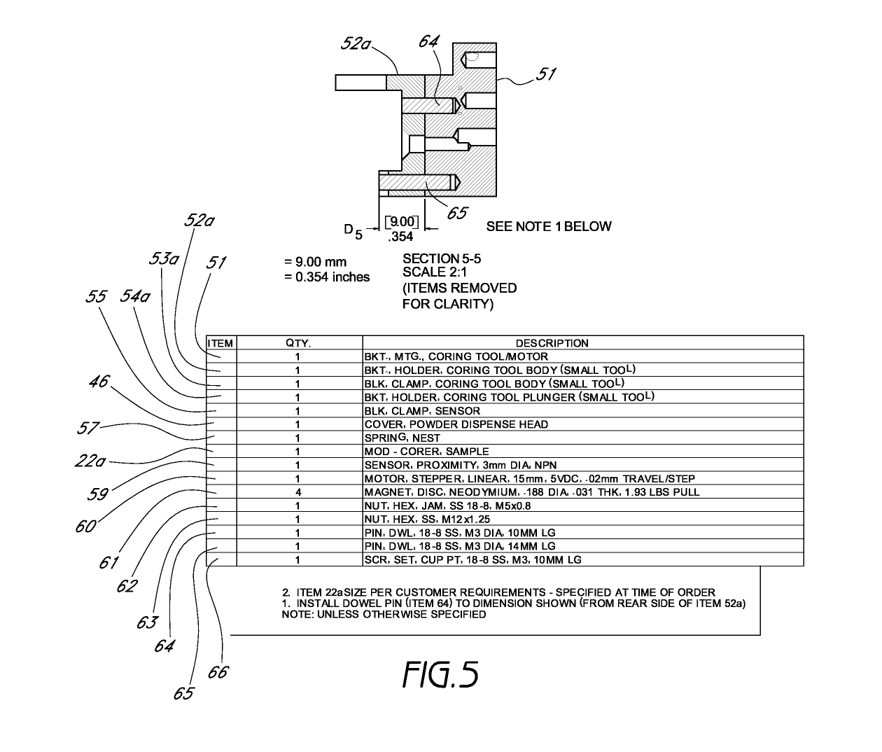

The dispense head assembly 12a generally comprises a probe assembly 22a, among other components. FIG. 5 includes a chart that identifies the general description of components denoted by reference numerals 51, 52a, 53a, 54a, 55, 46, 57, 22a, 59, 60, 61, 62, 63, 64, 65, and 66. In this chart, “BKT.” generally refers to bracket, “BLK.” generally refers to block, “MTG.” generally refers to mounting, “DWL” generally refers to dowel, and “SCR” generally refers to screw.

The dispense head assembly 12a is directed to a particular size of probe assembly 22a comprising a probe, tip, tube or corer 24a of a certain size adapted, dimensioned and/or configured for a particular application. The probe assembly 22a also comprises a probe barrel 48a and the dispense head assembly 12a comprises components 52a, 53a, 54a. One or more of these components are particularly adapted, dimensioned and/or configured to allow powder sampling for a particular application. For example, different mounts may be utilized to accommodate a particular probe barrel.

Referring in particular to FIG. 5, in one embodiment, the dimension D₅ is about 9 mm (0.354 inches). In one embodiment, during assembly, the dowel pin 64 is installed based on this dimension from a rear side of component 52a.

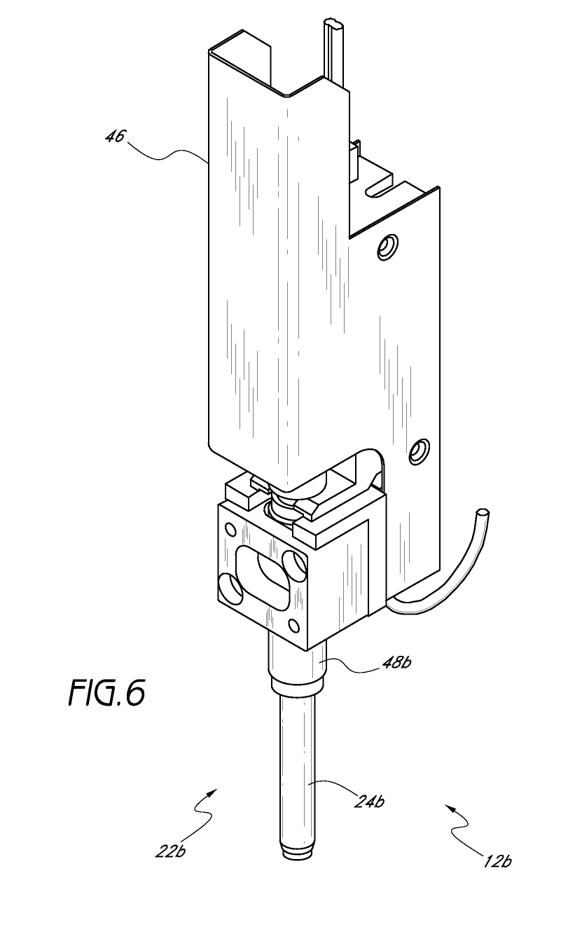

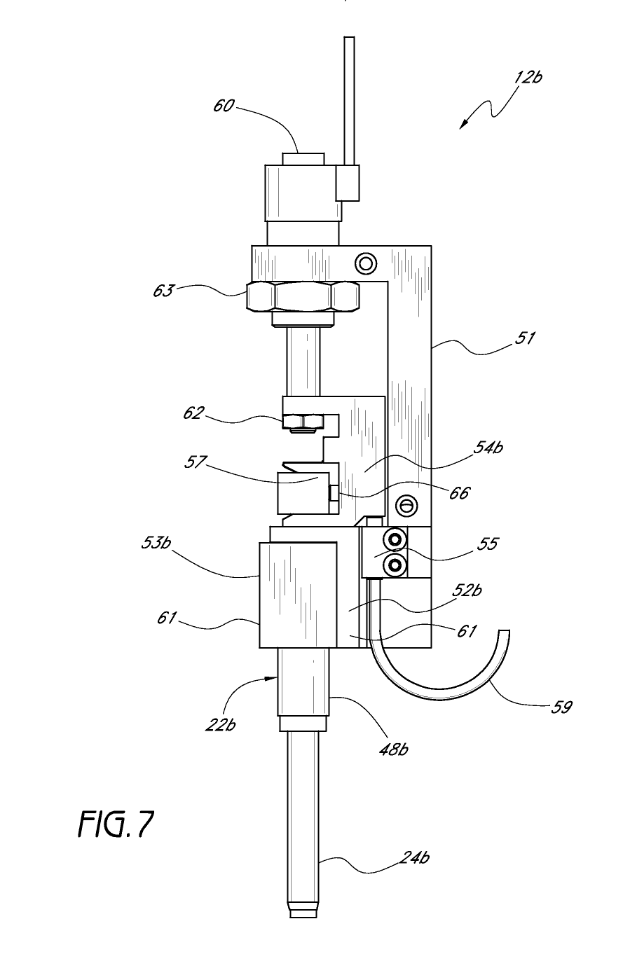

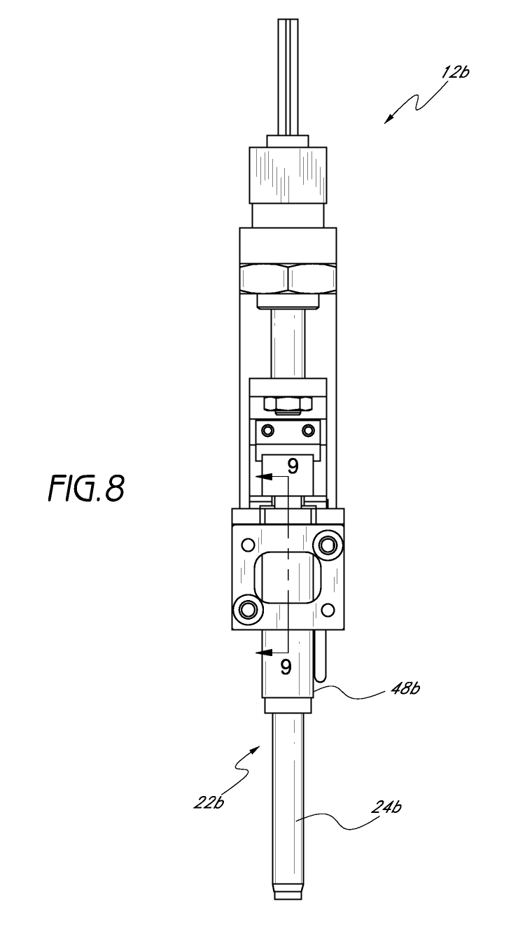

FIGS. 6-9 show different views of certain embodiments of a powder sampling and dispensing head assembly 12b. The dispense head assembly 12b is substantially similar to the dispense head assembly 12a except that it is dimensioned and/or configured to operate with a differently sized probe assembly 22b, as needed or desired, depending on the particular application.

In some embodiments, and as shown in FIG. 6, the dispense head assembly 12b comprises a cover 46 or the like. The cover 46 may be removable and/or replaceable, as needed or desired.

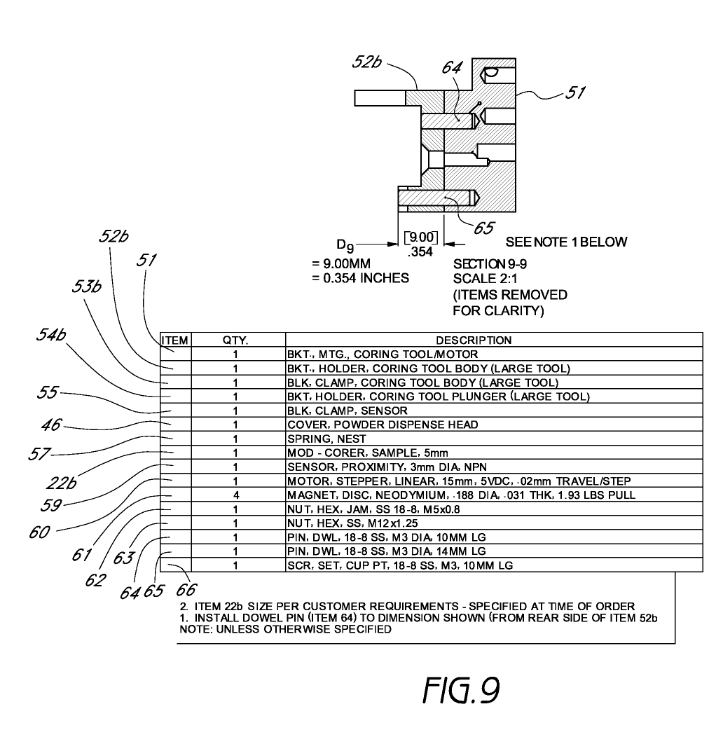

The dispense head assembly 12b generally comprises the probe assembly 22b, among other components. FIG. 9 includes a chart that identifies the general description of components denoted by reference numerals 51, 52b, 53b, 54b, 55, 46, 57, 22b, 59, 60, 61, 62, 63, 64, 65, and 66. In this chart, “BKT.” generally refers to bracket, “BLK.” generally refers to block, “MTG.” generally refers to mounting, “DWL” generally refers to dowel, and “SCR” generally refers to screw.

The dispense head assembly 12b is directed to a particular size of probe assembly 22b comprising a probe, tip, tube or corer 24b of a certain size adapted, dimensioned and/or configured for a particular application. The probe assembly 22b also comprises a probe barrel 48b and the dispense head assembly 12b comprises components 52b, 53b, 54b. One or more of these components are particularly adapted, dimensioned and/or configured to allow powder sampling for a particular application, as compared to embodiments of the dispense head assembly 12a of FIGS. 2-5. For example, different mounts may be utilized to accommodate a particular probe barrel.

Referring in particular to FIG. 9, in one embodiment, the dimension D₉ is about 9 mm (0.354 inches). In one embodiment, during assembly, the dowel pin 64 is installed based on this dimension from a rear side of component 52b.

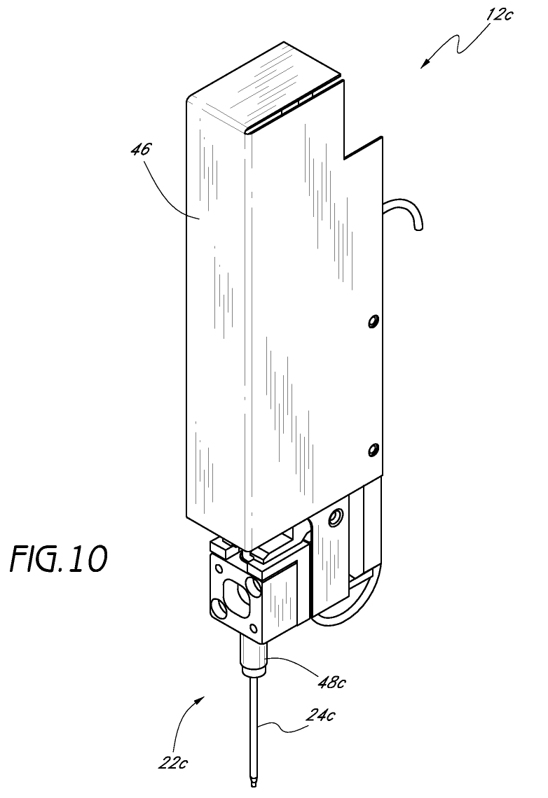

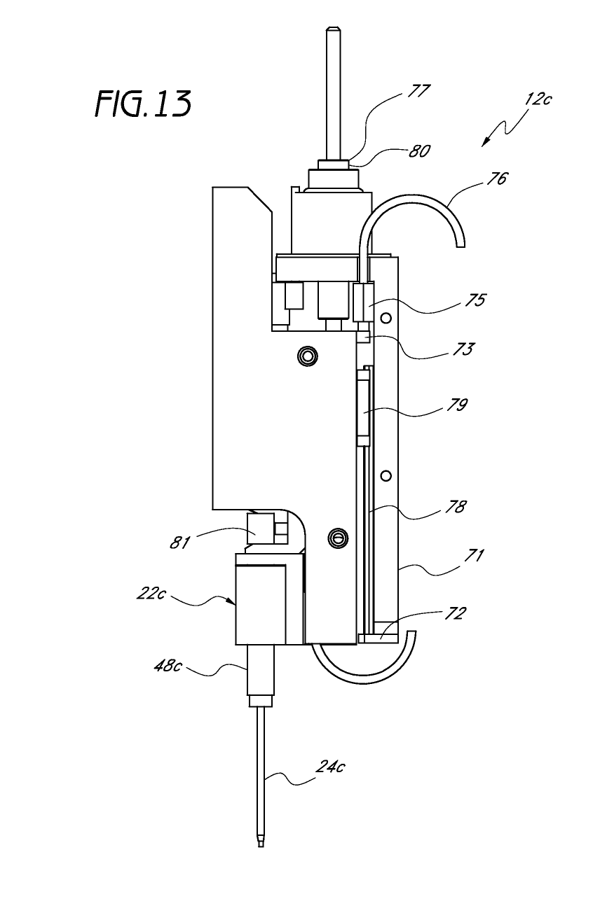

FIGS. 10-13 show different views of certain embodiments of a powder sampling and dispensing head assembly 12c. The dispense head assembly 12c is substantially similar to the dispense head assemblies 12a or 12b, except that it has an additional mobility feature and/or an extra dimensional capability wherein both the dispense head assembly 12c and its probe assembly 22c are independently moveable in a generally Z-axis or direction.

In some embodiments, and as shown for example in FIG. 10, the dispense head assembly 12c comprises a cover 46 or the like. The cover 46 may be removable and/or replaceable, as needed or desired.

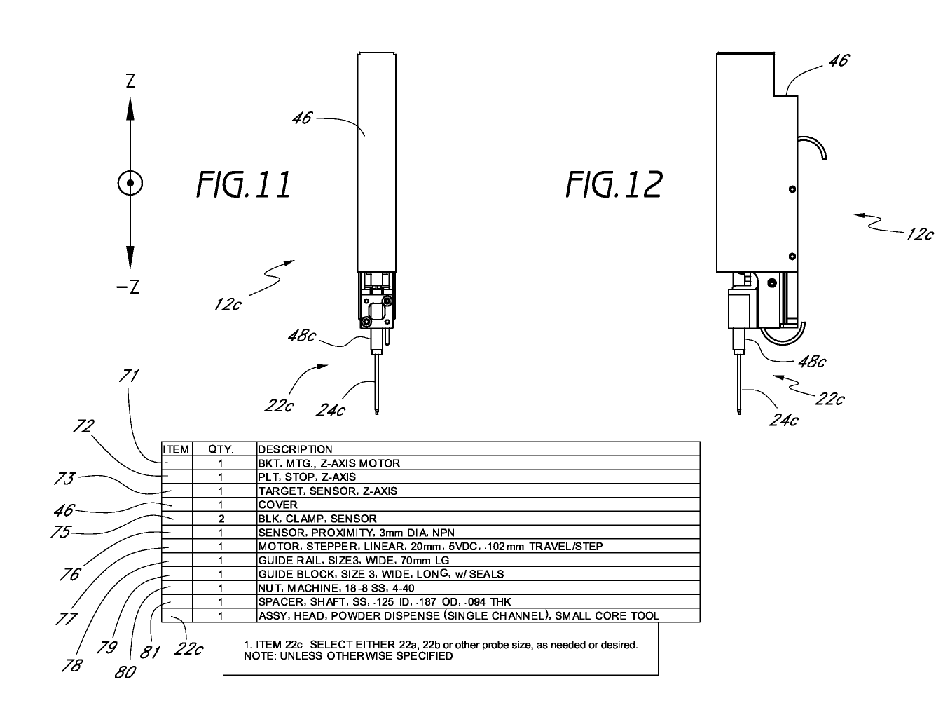

The dispense head assembly 12c generally comprises the probe assembly 22c, among other components. FIG. 11 includes a chart that identifies the general description of components denoted by reference numerals 71, 72, 73, 46, 75, 76, 77, 78, 79, 80, 81, and 22c. In this chart, “BKT.” generally refers to bracket, “BLK.” generally refers to block, “MTG.” generally refers to mounting, and “PLT” generally refers to plate.

In accordance with certain embodiments, the dispense head assembly 12c can incorporate any of a number of differently sized probe assemblies 22, probes 24 and other associated componentry with efficacy, as needed or desired. In one embodiment, the probe assembly 22a, probe 24a and other suitably dimensioned components are utilized. In another embodiment, the probe assembly 22b, probe 24b and other suitably dimensioned components are utilized.

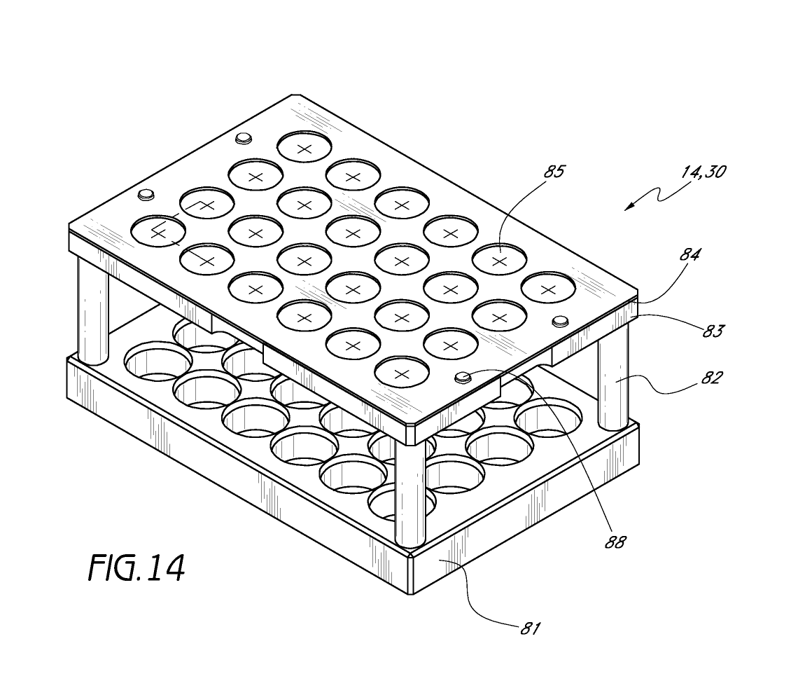

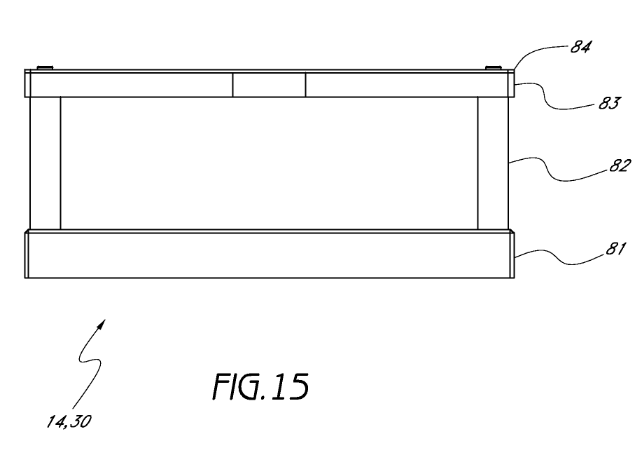

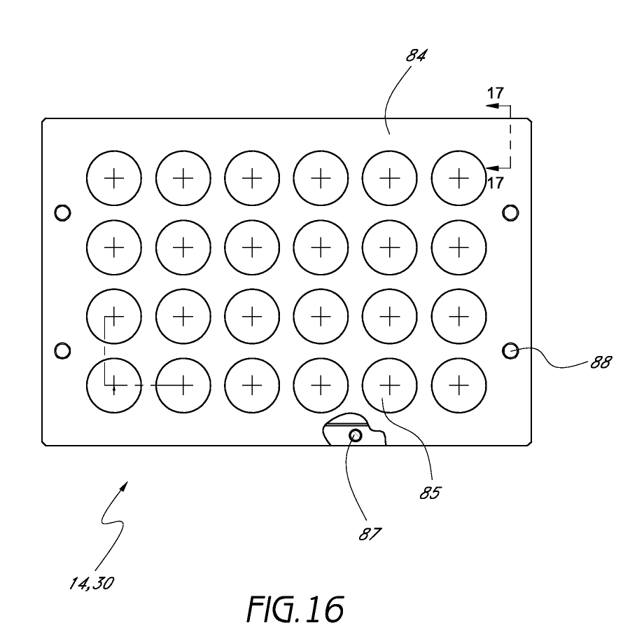

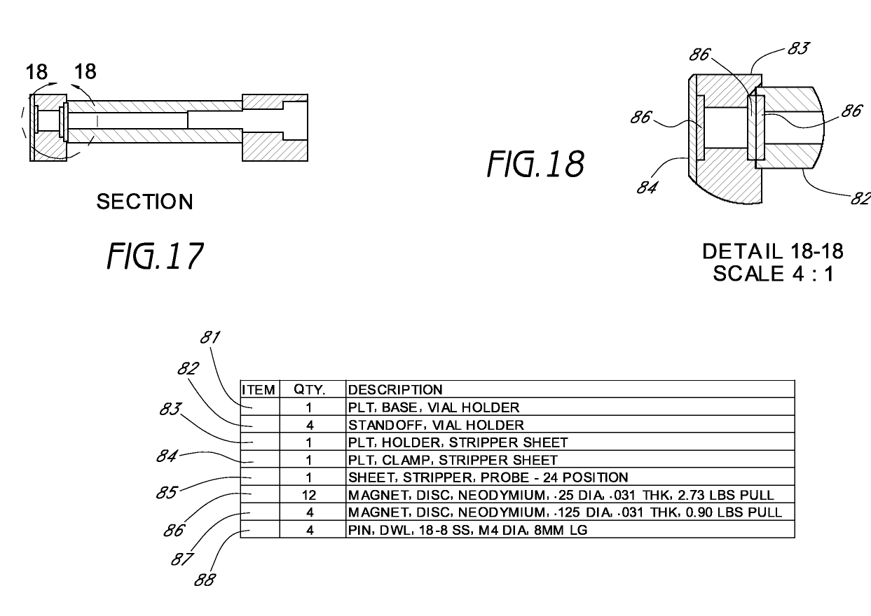

FIGS. 14-18 show different views of certain embodiments of a powder assembly 14 or vial holder assembly 30. The vials are not shown in these figures, but they would occupy and be arranged in a (4×6) configuration in these embodiments.

FIG. 18 includes a chart that identifies the general description of components denoted by reference numerals 81, 82, 83, 84, 85, 86, 87, and 88. Advantageously, in accordance with certain embodiments, the design of the flexible stripper sheet 85 allows entry of the sampling probe to access the source powder and strips, scrapes or shears off any excess powder that may be adhered to the probe outer surface as the probe is retracted from the powder source vials.

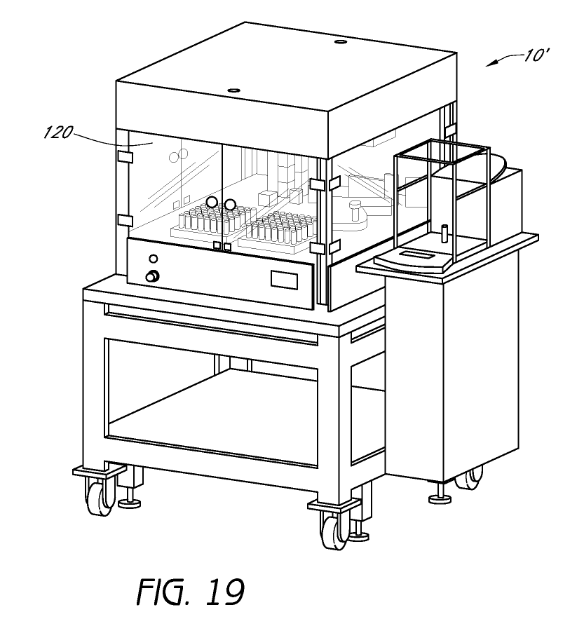

FIG. 19 shows a powder sampling and dispensing system 10′ in accordance with certain embodiments. The system 10′ comprises, among other things, one or more powder sample and dispense heads within an enclosure 120 or enclosed environment to conduct the powder handling operations.

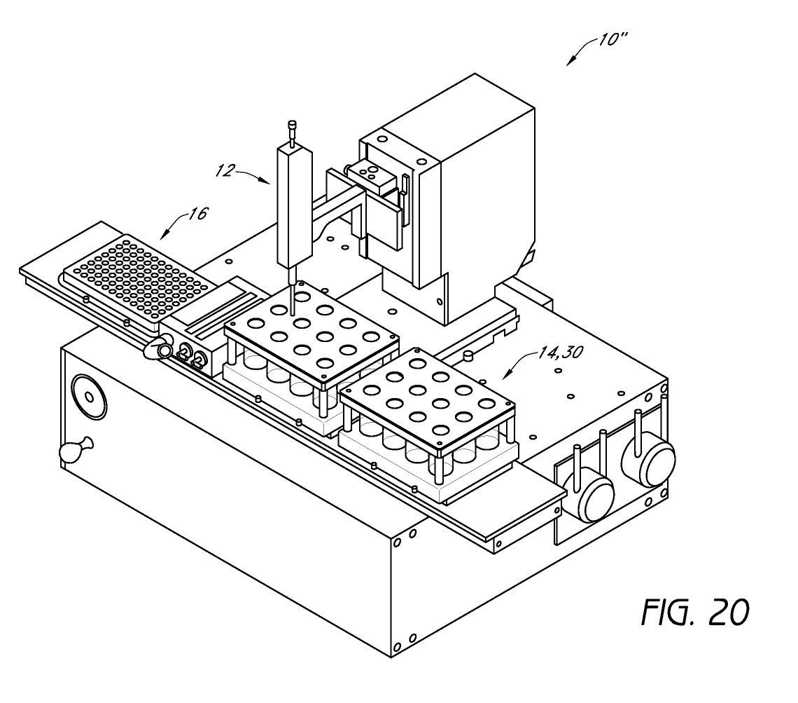

FIG. 20 shows a “benchtop” powder sampling and dispensing system 10″ in accordance with certain embodiments. The system 10″ comprises, among other things, a powder sample and dispense head 12, a powder source assembly 14 (and/or a vial holder 30), and a target assembly 16.

The solid dispenser system of certain embodiments comprises an automated system for transferring small amounts of solid material. Embodiments of this system are ideal for compound management tasks, where sampling directly from source vials is often desirable, and are also well suited for creating assay samples where studies need to be conducted in the solid state. This is particularly important in pharmaceutical pre-formulation studies. The system embodiments do not rely on vibratory feeding and are therefore not prone to the problems encountered in this type of mechanism; namely segregation and biased sampling. As a result, the embodiments of the system are ideally suited for applications involving heterogeneous sample mixtures, where vibratory approaches would be unsuitable.

In some embodiments, the powder handling or manipulating system can work with as little as 50 mg or less of starting material. In some embodiments, the powder handling or manipulating system can dispense material having a mass in the range from about 100 micrograms (μg) to about 20 milligrams (mg), including all values and sub-ranges therebetween.

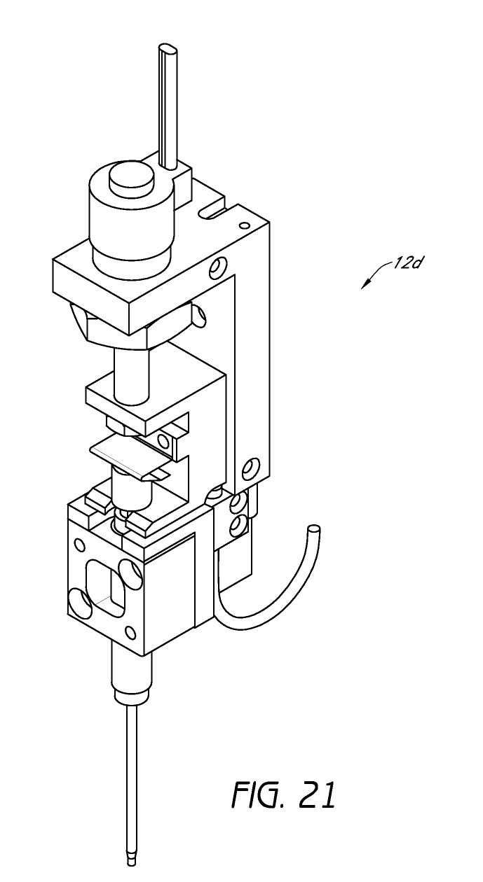

FIGS. 21-27 show views of various embodiments of a powder sampling and dispensing head assembly. In some embodiments, the overall head motion (e.g. in the Z-direction) is controlled by a pneumatic or motor driven actuator. In some embodiments, the dispense head assembly comprises a variable volume plunger motor which incorporates a micrometer or the like. One or more limit switches are provided, in certain embodiments, to serve as motion stops or the like. In some embodiments, a pneumatic mode is utilized for powder ejection. In some other embodiments, a motorized mode is utilized for powder aspiration or sampling. A mount, in some embodiments, can cover substantially the entire probe barrel or can allow at least a portion of the probe barrel to be exposed with efficacy, as needed or desired, depending at least on the particular application and/or the dimensional configuration of the powder source or vial.

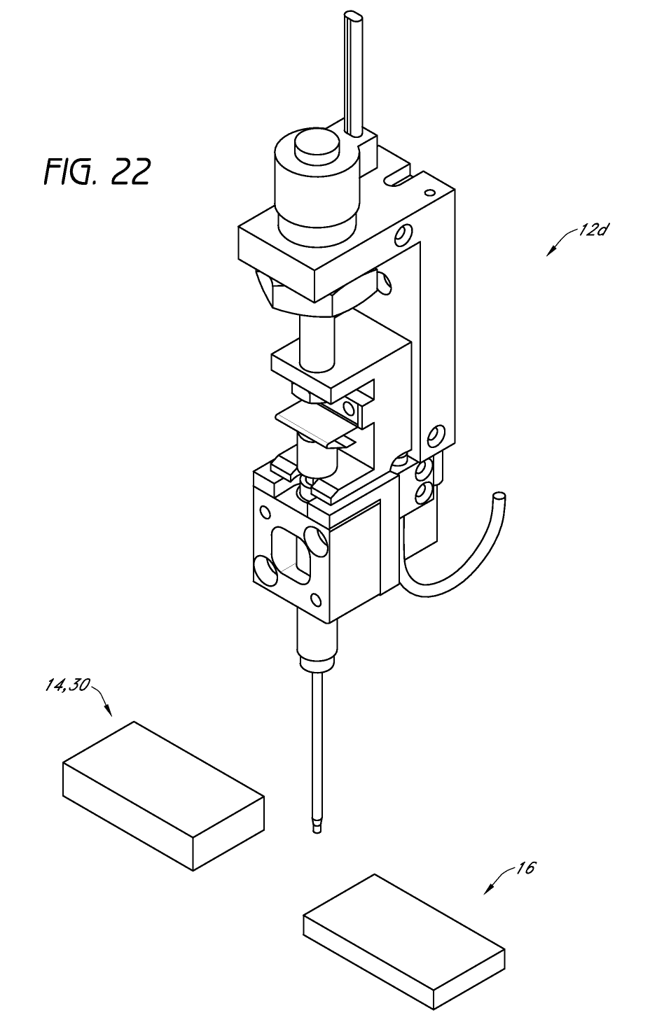

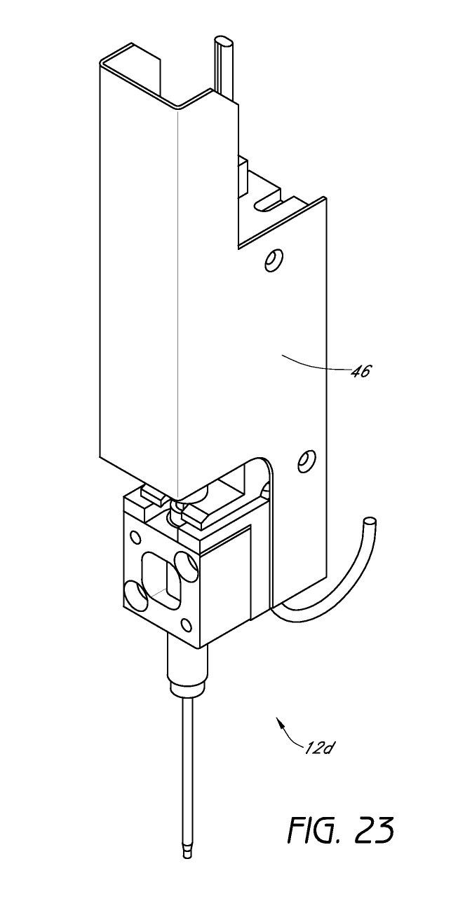

Referring in particular to FIGS. 21-23, a powder sampling and dispensing head assembly 12d is shown. FIG. 22 also shows a powder source assembly 14 (and/or a vial holder 30) and a target assembly 16. FIG. 23 shows the powder handling head assembly 12d with a cover 46.

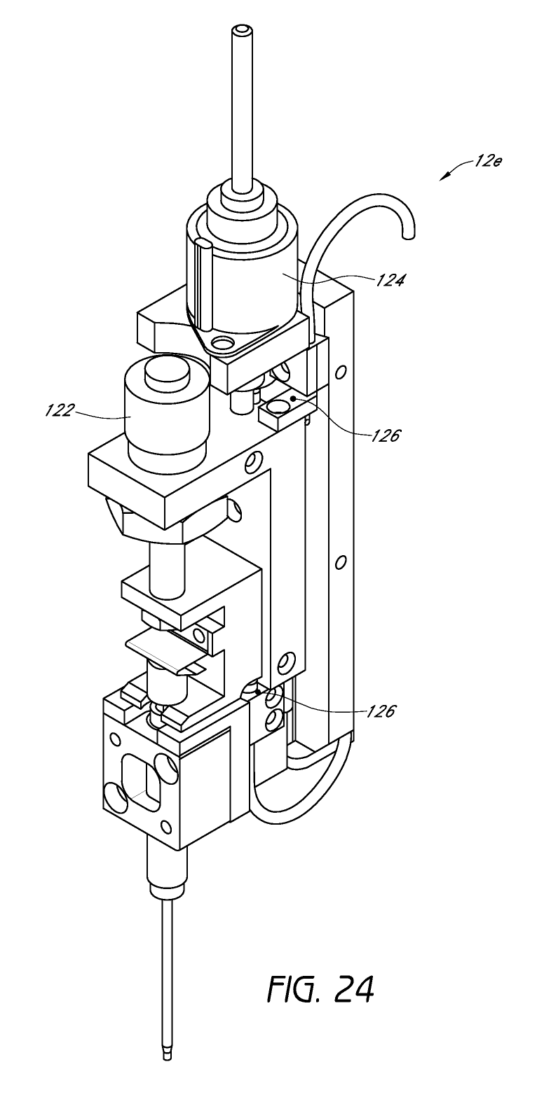

Referring in particular to FIG. 24, a powder sampling and dispensing head assembly 12e is shown. In some embodiments, the overall head motion (e.g. in the Z-direction) is controlled by a pneumatic or motor driven actuator 124. In some embodiments, the dispense head assembly 12e comprises a variable volume plunger motor 122 which incorporates and is controlled by a micrometer or the like. One or more limit switches 126 are provided, in certain embodiments, to serve as motion stops or the like. In some embodiments, a pneumatic mode is utilized for powder ejection. In some other embodiments, a motorized mode is utilized for powder aspiration or sampling.

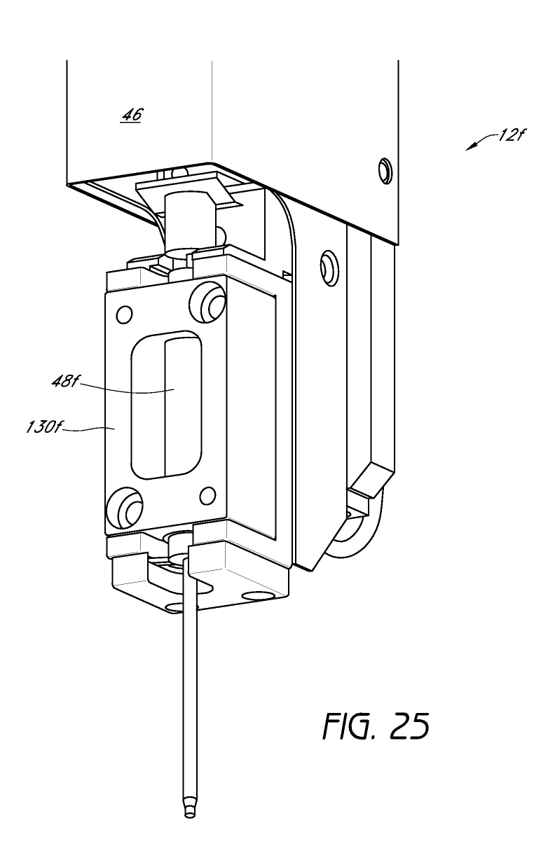

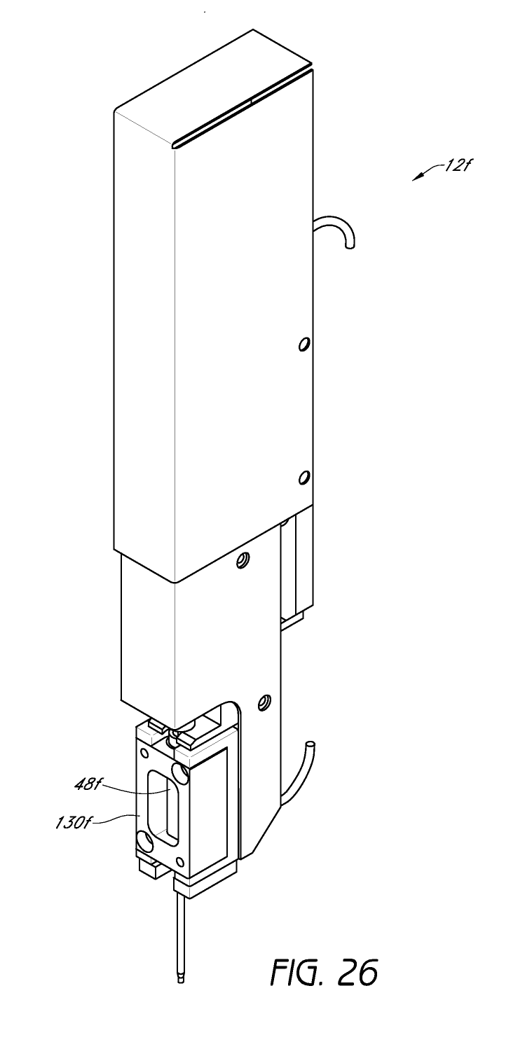

Referring in particular to FIGS. 25 and 26, a powder sampling and dispensing head assembly 12f is shown. A mount 130f, in some embodiments, covers substantially the entire barrel 48f of the probe assembly.

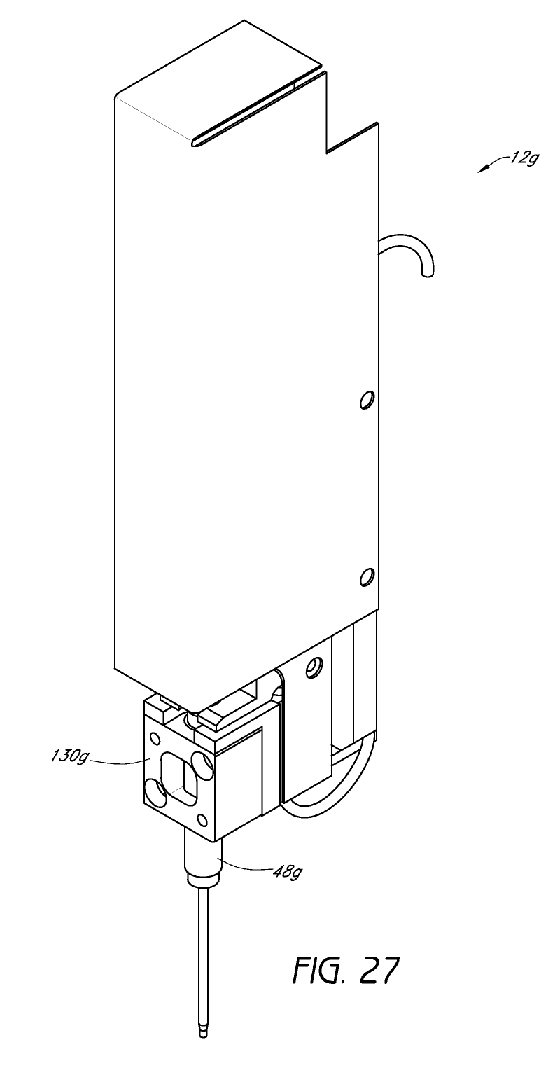

Referring in particular to FIG. 27, a powder sampling and dispensing head assembly 12g is shown. A mount 130g, in some embodiments, allows at least a portion of the barrel 48g of the probe assembly to be exposed.

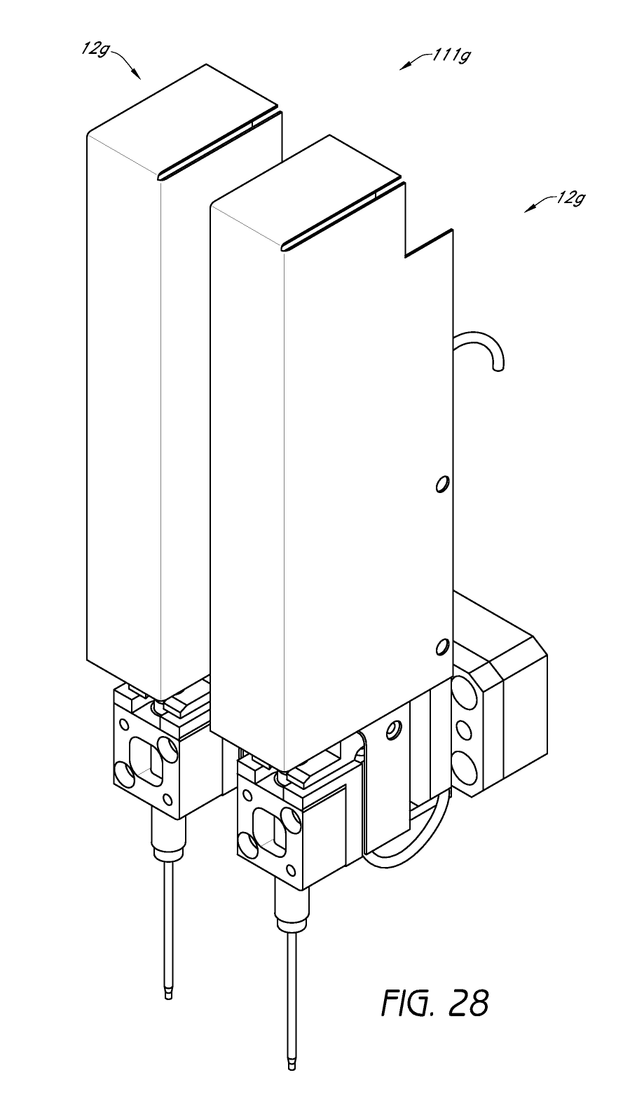

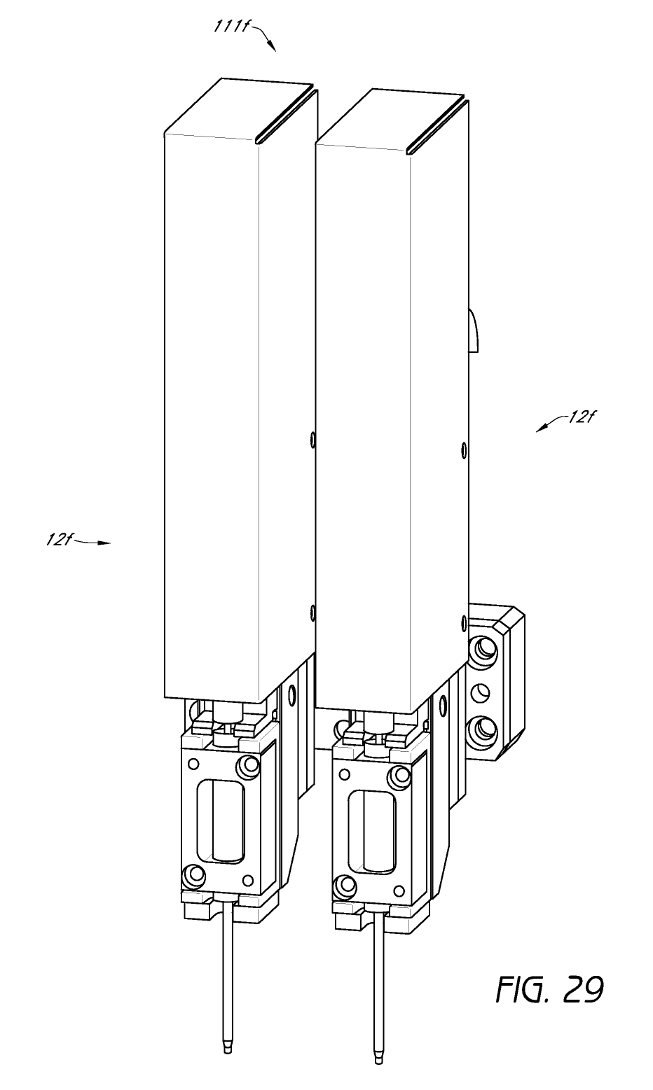

FIGS. 28 and 29 show views of various embodiments of a multi-channel powder sampling and dispensing head assembly. A plurality of sampling and dispense channels (e.g., arranged in a one-dimensional or two-dimensional array) may be employed. The dispense channels of the multi-channel system may be differently configured with respect to one another, as needed or desired.

Referring in particular to FIG. 28, a multi-channel powder sampling and dispensing head assembly 111g is shown. The multi-channel head assembly lug comprises at least two of the powder sampling and dispensing head assemblies 12g. The multi-channel head assembly 111g may also comprise any of the other powder sampling and dispensing head assemblies (e.g., 12e, 12f) disclosed herein with efficacy, as needed or desired.

Referring in particular to FIG. 29, a multi-channel powder sampling and dispensing head assembly 111f is shown. The multi-channel head assembly 111f comprises at least two of the powder sampling and dispensing head assemblies 12f. The multi-channel head assembly 111f may also comprise any of the other powder sampling and dispensing head assemblies (e.g., 12e, 12g) disclosed herein with efficacy, as needed or desired.

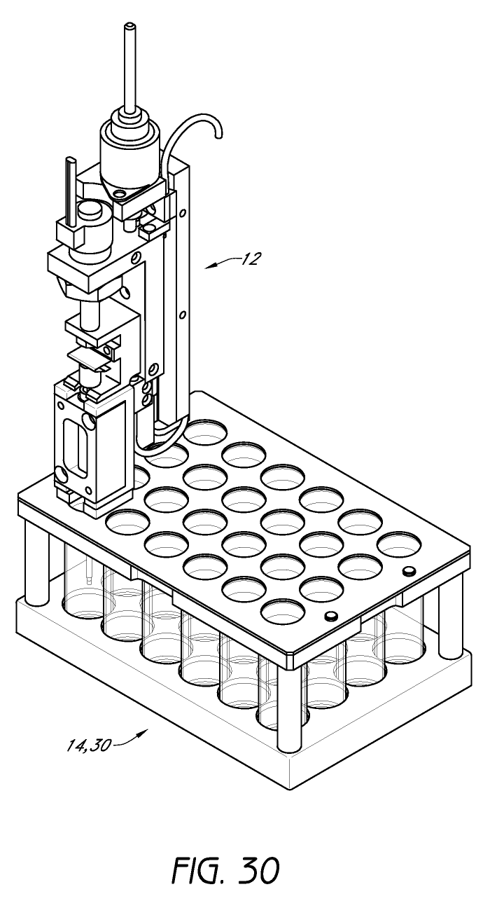

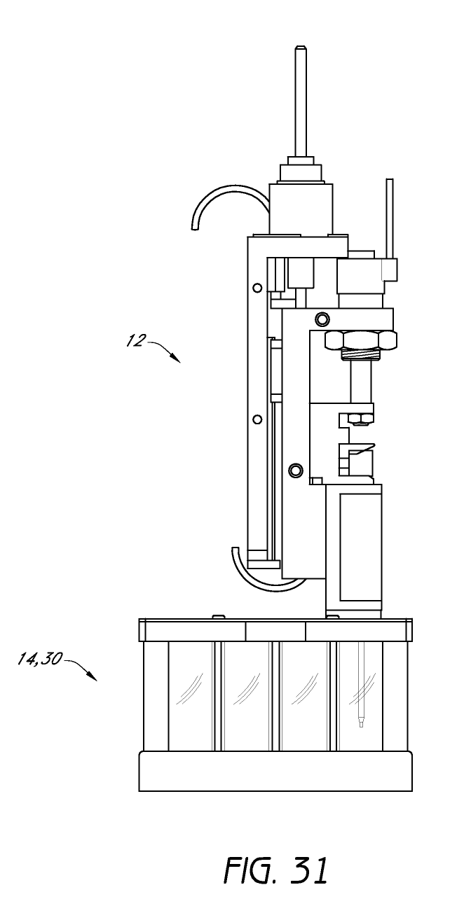

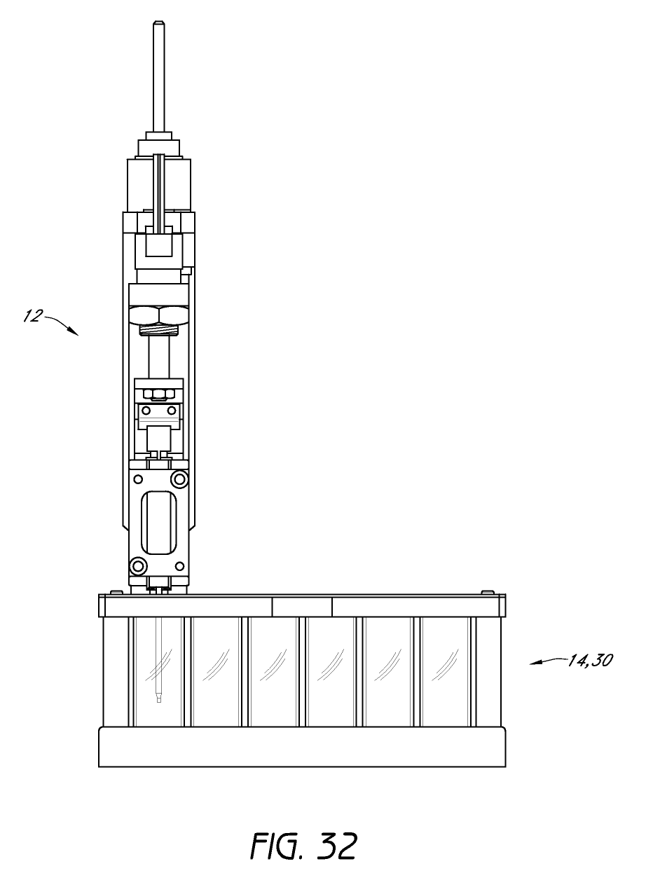

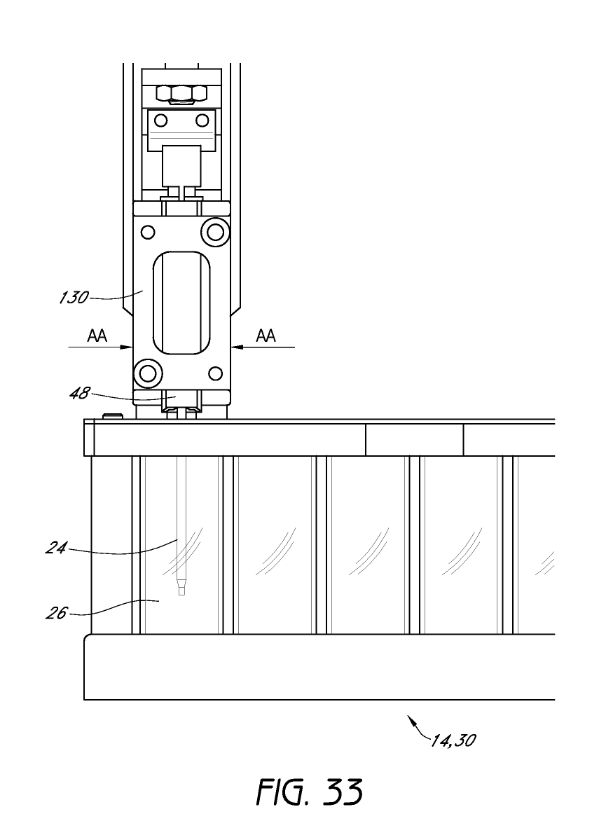

FIGS. 30-33 show various views of certain embodiments of a powder sampling and dispensing head assembly 12 engaged with a powder source or vial assembly or holder 14, 30. In some embodiments, the size or length of the mount 130 can be reduced (e.g., as generally shown by arrows AA in FIG. 33) so that probe barrel 48 can travel into the vial 26 and the probe or tip 24 can reach deeper down into the vial 26, as needed or desired, depending at least on the particular application. The probe barrel size (e.g., diameter and/or length), in some embodiments, can also be efficaciously varied to allow or deny access into the vial, as needed or desired, depending at least on the particular application.

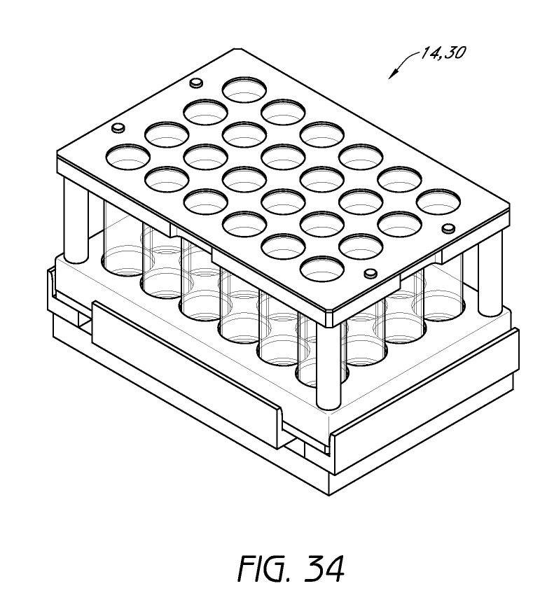

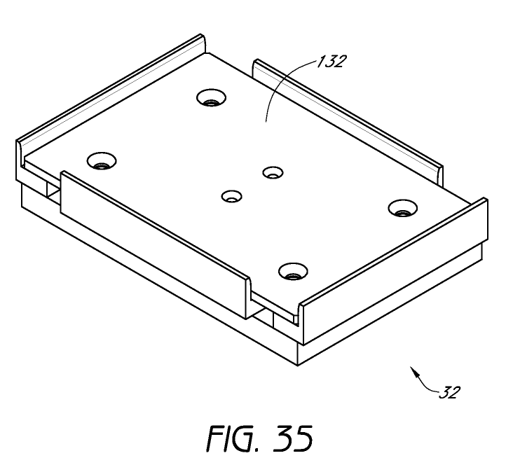

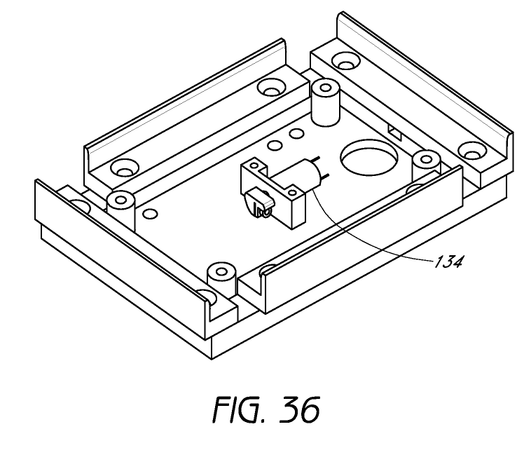

FIGS. 34-36 show various views of certain embodiments of a powder source or vial holder assembly 14, 30 and some of its componentry. The vial holder assembly 14, 30, in some embodiments, comprises a vibration plate 132 driven by a vibration motor 134 to provide controlled vibration and shaking to the powder containing vials, for example, to facilitate powder settling in the vial after a sampling operation. The vibration motor 134 can efficaciously be mounted on any suitable location of the vial holder assembly 14, 30, such as at a lower, upper or intermediate position, as needed or desired.

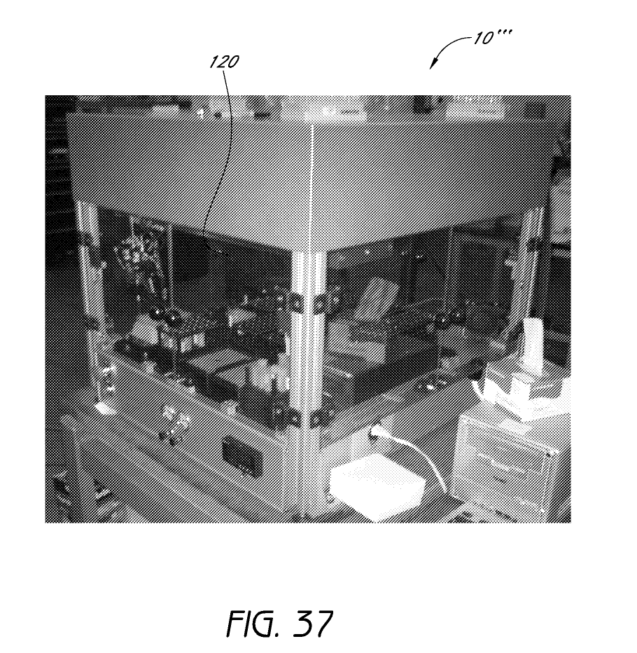

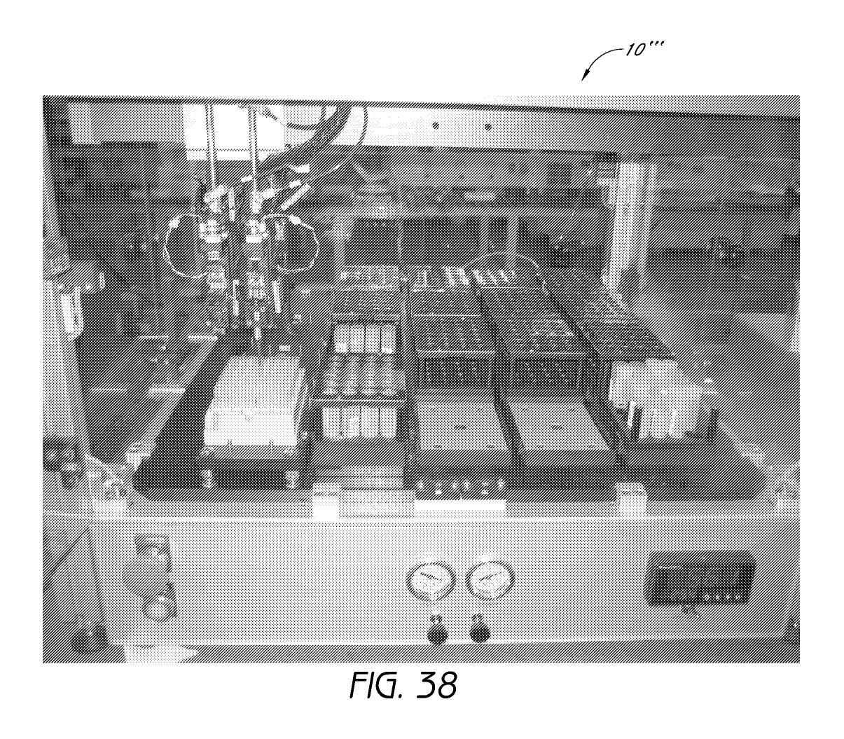

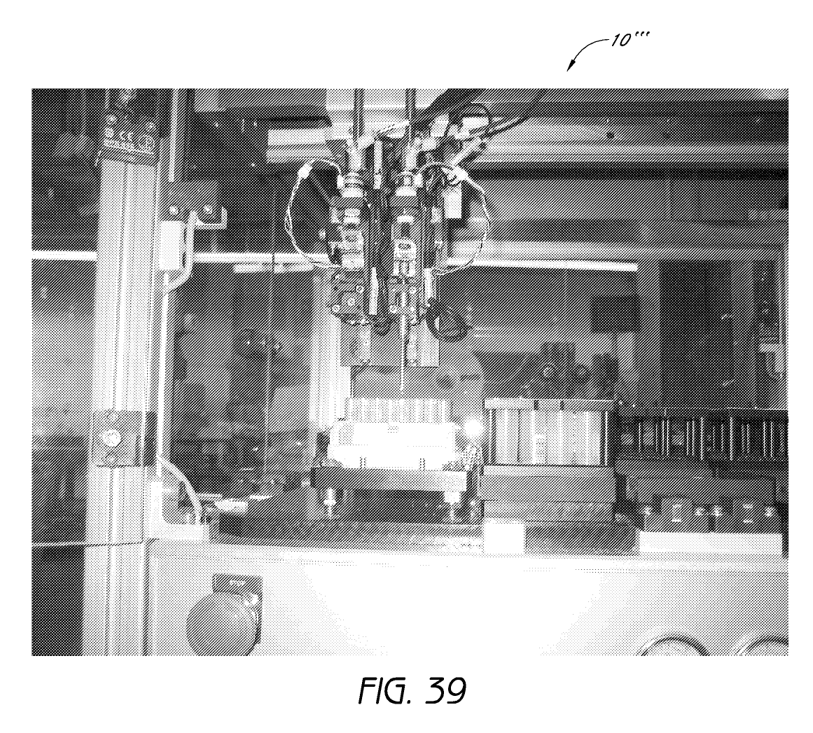

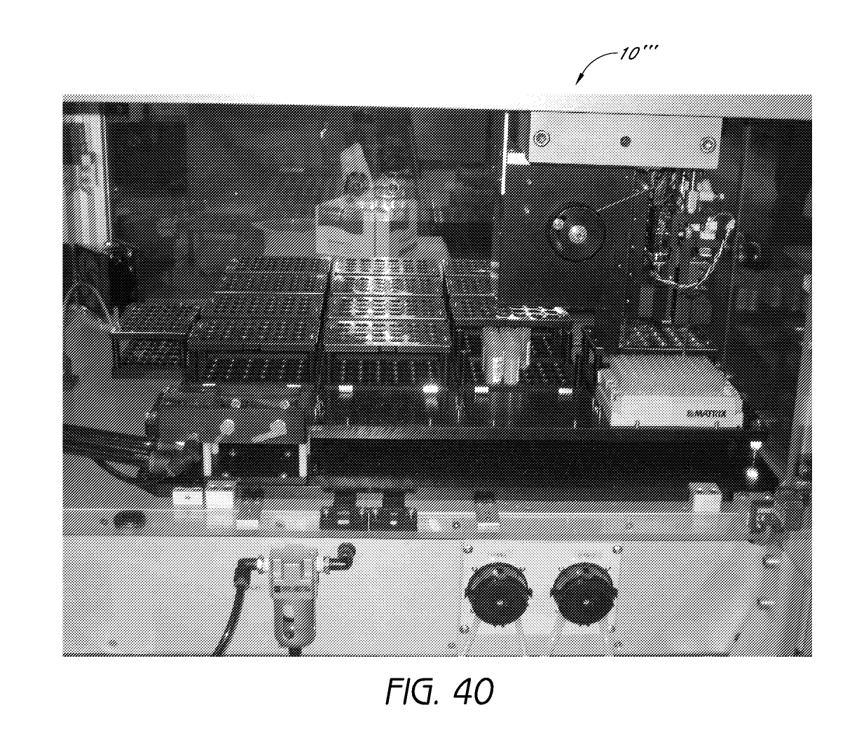

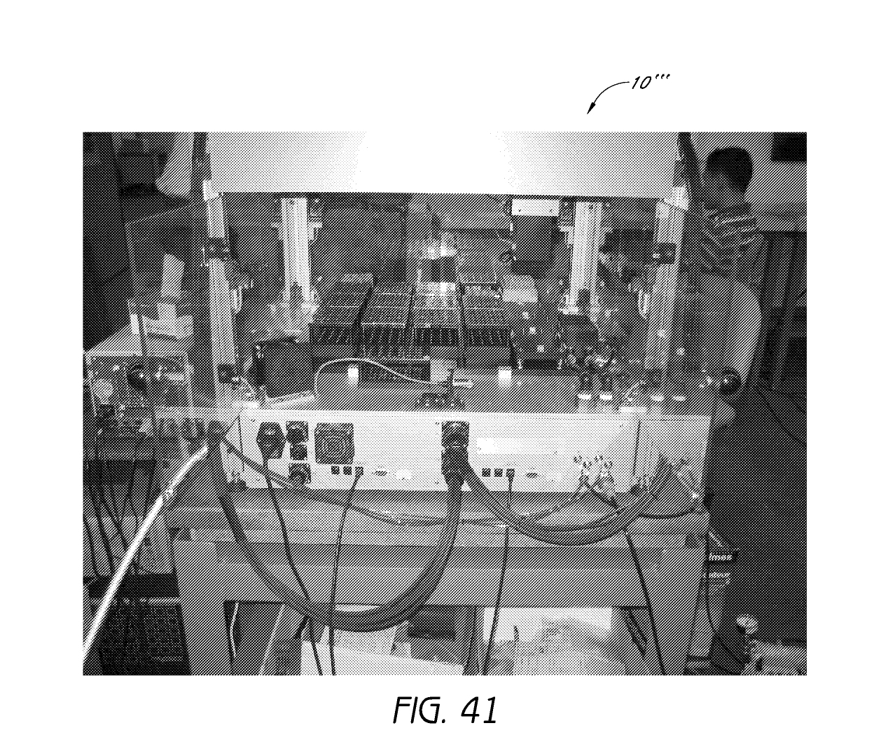

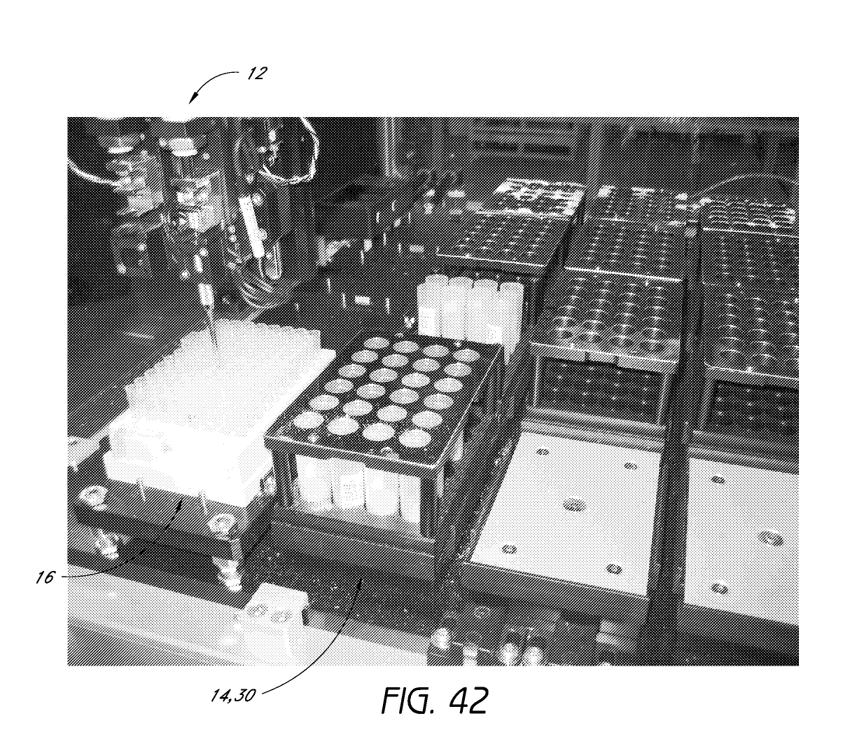

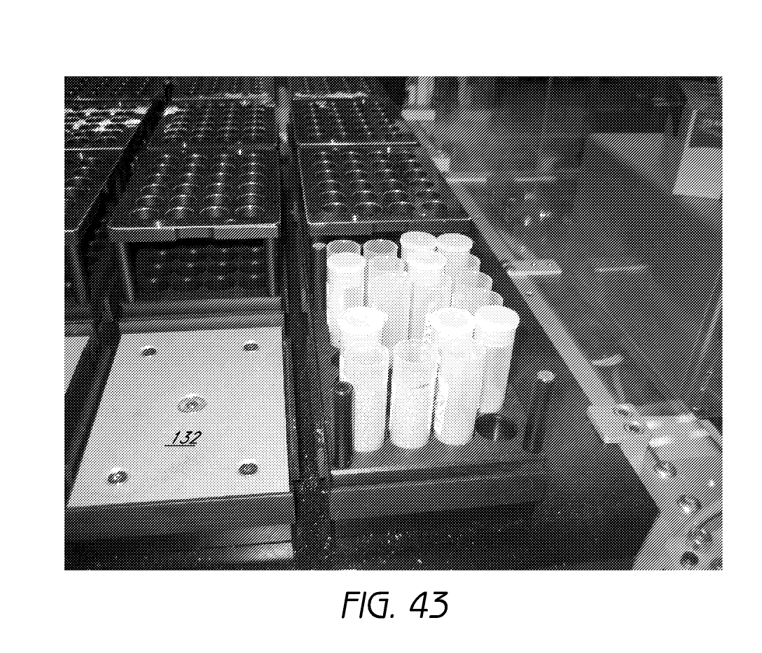

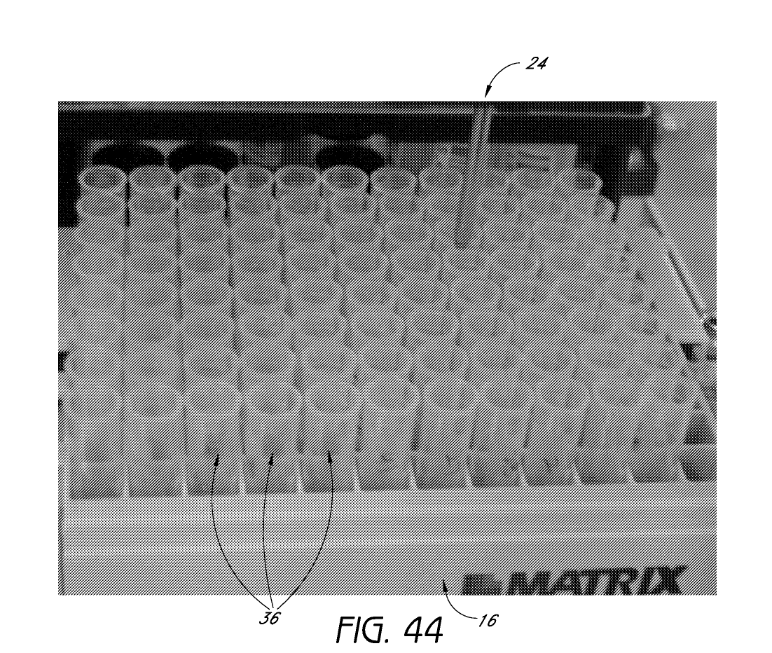

FIGS. 37-44 show views of various embodiments of a powder sampling and dispensing system 10′″ and some of its components. These figures represent pictorial views of a laboratory and/or R&D environment or setting. The system 10′″ comprises, among other things, one or more powder sample and dispense head assemblies 12 (see, e.g., FIG. 42) within an enclosure 120 (see, e.g., FIG. 37) or enclosed environment to conduct the powder handling operations. The powder source assembly 14 (and/or the vial holder 30) and the target assembly are also labeled in FIG. 42. A vibration plate 132 of the vial holder assembly 14, 30 is best seen in FIG. 43. A powder handling probe, tip or corer 24 and a target assembly 16 comprising a plurality of target vials or containers 36 are illustrated in FIG. 44

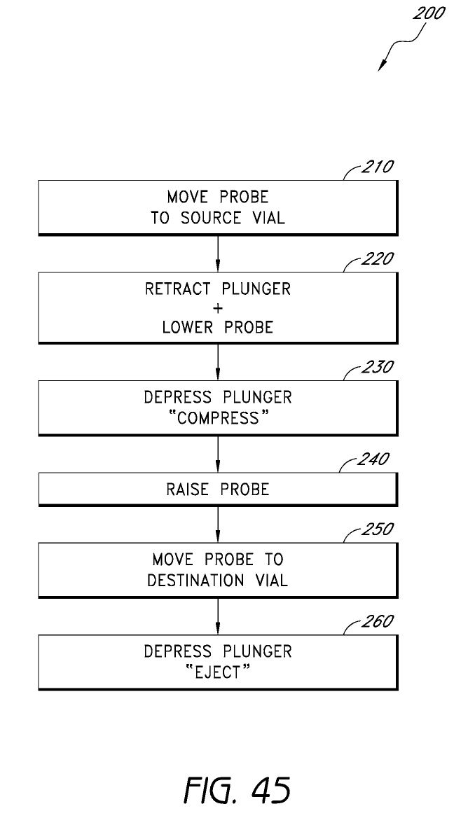

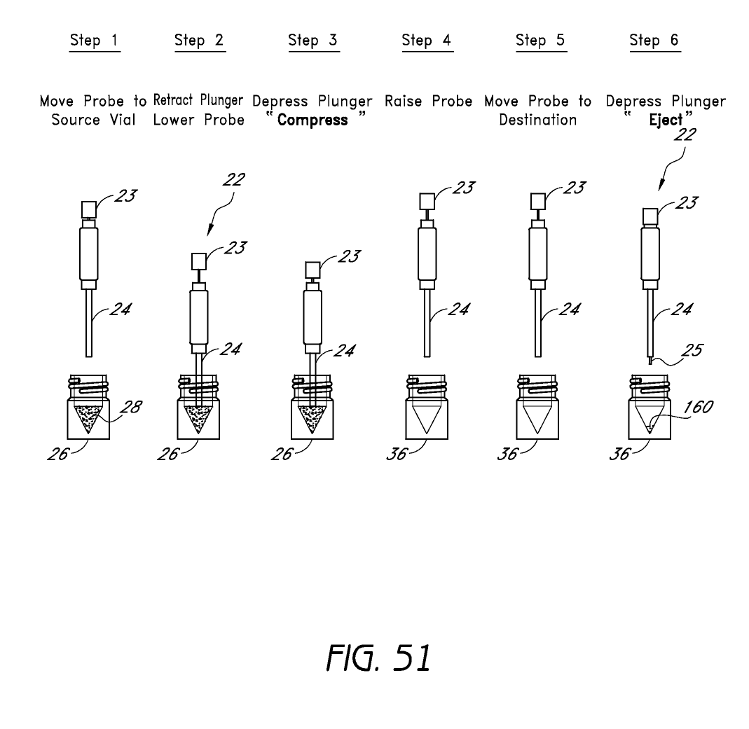

FIG. 45 shows certain embodiments of a powder sampling and dispensing process or method as depicted by a flowchart 200 or the like. Any of the powder sampling and dispensing systems taught or suggested herein may be utilized and/or configured to perform the step or acts of the method or process flowchart 200. (This method or process is discussed in further detail in connection with FIG. 51.)

In step or act 210, a powder handling probe is moved to a powder source vial. In step or act 220, a plunger of the powder handling dispense head is retracted and the probe is lowered into the powder vial. In step or act 230, the plunger is depressed to compress the powder to facilitate accurate loading within the probe. In step or act 240, the probe is raised out of the vial. In step or act 250, probe is moved to the destination or target vial. In step or act 260, the plunger is depressed to eject or dispense a predetermined quantity of the powder loaded in the probe into the target vial.

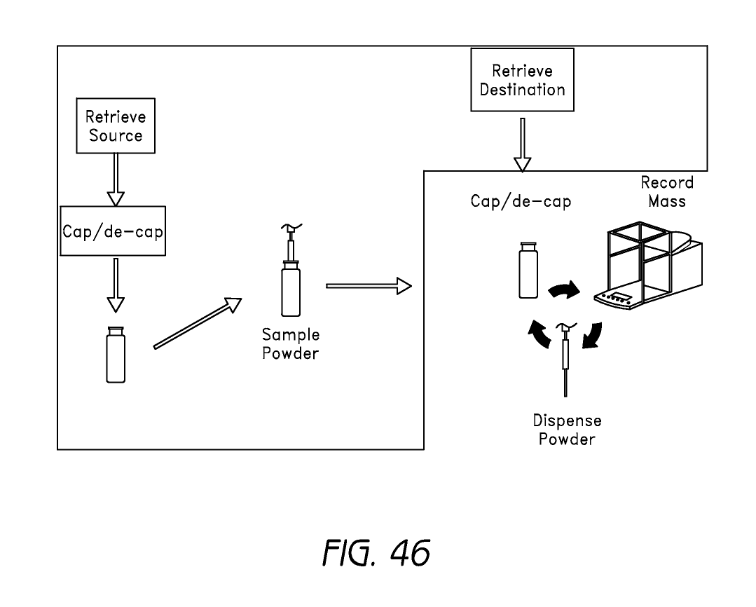

FIG. 46 shows an overview of certain embodiments of some operational steps for sampling and delivering powders. Any of the powder sampling and dispensing systems taught or suggested herein may be utilized and/or configured to perform this process.

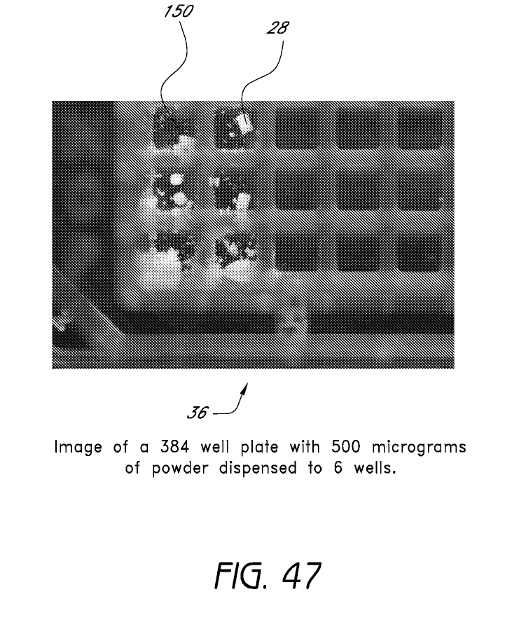

FIG. 47 shows a 384 well plate 36 with about 500 micrograms (μg) of powder 28 dispensed into 6 wells 150. Any of the powder sampling and dispensing systems taught or suggested herein may be utilized and/or configured to deliver this powder(s).

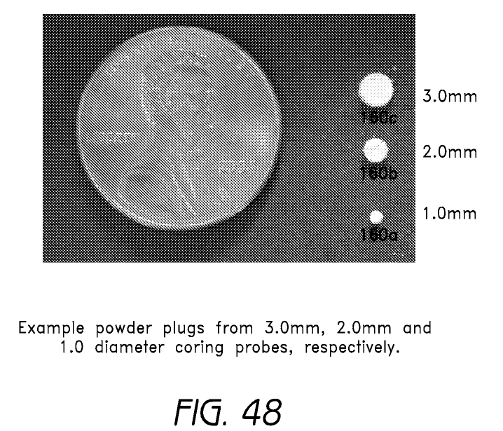

FIG. 48 shows of exemplary embodiments of powder plugs 160a, 160b, 160c delivered from respective 1.0 mm, 2.0 mm and 3.0 mm diameter coring probes. Any of the powder sampling and dispensing systems taught or suggested herein may be utilized and/or configured to deliver these powder plugs 160a, 160b, 160c.

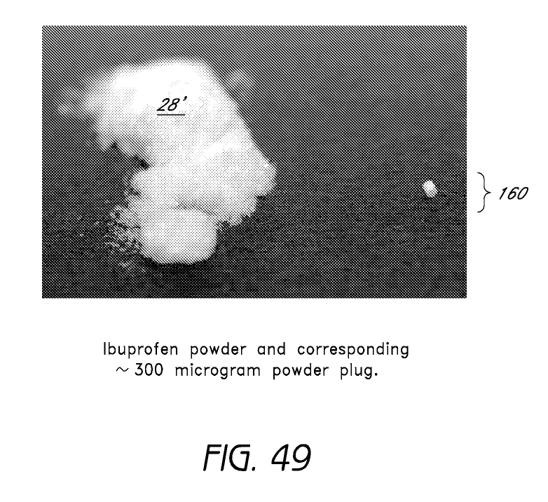

FIG. 49 shows ibuprofen powder 28′ and exemplary embodiments of a delivered powder plug 160 with a mass of about 300 micrograms (fig). Any of the powder sampling and dispensing systems taught or suggested herein may be utilized and/or configured to sample the Ibuprofen powder 28′ and dispense the corresponding powder plug 160.

### Technology Notes Relating to Some Powder Dispensing Embodiments

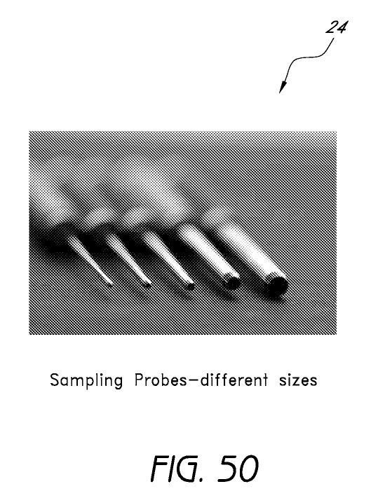

FIGS. 50-60 show various embodiments of some features, aspects and advantages relating to embodiments of the systems and methods for sampling and dispensing powders. These figures, in at least some cases, relate to the propriety DiSPo™ Powder Dispensing Technology as available from Entevis Inc. of Sudbury, Mass., U.S.A.

This powder handling technology involves the volumetric delivery of dry powders and solids. The technology advantageously can be employed on several different platforms to create automated workstations for dispensing powders and solids. The desirable and versatile use of the powder handling embodiments disclosed herein is further supported by characterization data to exemplify its use in a wide variety of applications, as discussed herein and below.

The ability to dispense dry powders and solids is a valuable tool for materials discovery, development and optimization, among other applications. There are few currently available options for automated manipulation of dry powders, particularly in the microgram mass range. The powder handling technology embodiments disclosed herein advantageously provide an automated means to deliver a wide variety of powders over the mass range of 100 micrograms or more to 20 milligrams or less. In some embodiments, powders are dispensed via a volumetric delivery from a sample probe. This volume, combined with the bulk density of the powder being sampled, generally determines the mass that is delivered. There are several sample probe choices to chose from, based on the target mass (and therefore volume) to be delivered. FIG. 50 shows a photograph of five different probes 24, among others, available for use with embodiments of the powder sampling and dispensing systems and methods.

The sampling of powders can occur from many different source vessels, including microwell plates, scintillation vials, dram vials, tube-based storage systems, among others. Delivery can occur to the same formats as well. FIG. 51 shows schematically how powders are sampled and delivered, in accordance with certain embodiments.

Referring in particular to FIG. 51, a powder sampling and dispensing assembly head 22 comprises a probe, tip or corer 24 which operates in conjunction with a movable plunger 23. The plunger 23 can be considered as comprising part of the probe 24 or as part of the probe assembly 22, or as an independent component. Also shown are a source vial 26 and a powder 28 therein for sampling and delivery. The plunger 23 comprises a solid rod 25 or the like that is slideably or axially moveable (e.g., in a generally Z-direction) within a bore or lumen of the probe 24.

In brief, and still referring in particular to FIG. 51, in some embodiments, the adjustable plunger 23 with the plunger rod 25 within the sampling probe 24 allows for the setting of a “fill height” within the probe 24. This fill height and the diameter of the probe 24, in certain embodiments, determines the sampling volume of powder 28. The sample probe 24 is lowered into the powder 28, where it extracts the determined volume, amount or quantity of powder 28. This process is generally indicated by the first 3 steps in FIG. 51. The probe 24 is then moved out of the source location 26 and moved over to the destination location 36. It should be noted that at this stage the plunger 23 is still retracted. Once over the destination location or target vial 36, the plunger 23 is actuated and the powder (plug) 160 is delivered into the target location 36. In some embodiments, the powder delivery or dispense comprises a non-contact positive dispense operation. This process is indicated by the last 3 steps in FIG. 51. In certain embodiments, this process is advantageously automated and programmable through a control software interface of embodiments of the powder handling system.

In more detail, and still referring in particular to FIG. 51, in some embodiments, the first step or act involves positioning or moving the probe 24 over the powder source or vial 26 containing the powder 28 to be handled.

In the second step or act, in some embodiments, the plunger 23 is retracted from within the bore or lumen of the probe 24 to allow a volumetric space therein for sampling or aspirating the source powder 28. More specifically, the plunger rod 25 is retracted and the probe 24 is lowered or inserted into the powder source 26.

In the third step or act, in some embodiments, the plunger 23 is depressed or actuated so that the plunger rod 25 is displaced towards and into the source powder 28. More specifically, this step involves compression of the powder within the probe lumen to advantageously achieve a certain powder bulk density to allow for generally accurate sampling of a predetermined mass, volume, amount or quantity of the powder 28 into the bore or lumen of the probe 24.

In the fourth step or act, in some embodiments, the probe 24 is raised or removed from the powder source 36. At this stage, a predetermined mass, volume, amount or quantity of the powder 28 has been loaded into the probe 24 for delivery in one or more dispensing operations.

In the fifth step or act, in some embodiments, the probe 24 is moved or positioned over the target or vial 36. This target vial 36 is at least one of the locations wherein or whereat the sampled powder is to be delivered or dispensed.

In the sixth step or act, in some embodiments, the plunger 23 is depressed or actuated so that the plunger rod 25 is displaced towards the target or vial 36. This dispenses a predetermined mass, volume, amount or quantity of the sampled powder 28 into the target 36 as indicated by dispensed powder material 160 in the form of, for example, a powder plug or the like, with efficacy, as needed or desired.

Several experiments have been conducted in order to demonstrate the effectiveness, reliability and accuracy of embodiments of the powder handling technology embodiments disclosed herein. For example, among other experimental studies, 20 different powders were characterized. These powders were chosen to be representative of the typical powder properties to be encountered in real world applications. Some of these properties include flowability (good and poor), granularity (course and fine), crystallinity (crystalline and amorphous), particle size (small and large) and bulk density (low and high). The ability and performance of delivering a range of powder volumes/masses, both within a sample probe and between sample probes with different diameters, was also studied.

Moreover, several methods in accordance with embodiments of the invention and materials were studied. For example, for characterization of the powder handling technology embodiments disclosed herein, the following powders were used: cab-o-sil, Avicel PH101, garlic powder, magnesium stearate, ibuprofen, powdered sugar (10×), cocoa, cinnamon, acetaminophen, silica gel, corn starch, granulated sugar, flour, baking soda, acetylsalicylic acid, talcum powder, baking powder, grout, table salt and naproxen sodium. The powders used in generating at least some of the results reported herein were either obtained as direct samples from manufacturers or were purchased from distributors or vendors (e.g. Sigma-Aldrich). Correlation of dispensed volume to mass was determined by dispensing discrete volumes and weighing using a calibrated analytical balance (Mettler-Toledo AG245). Measurements were made in triplicate, at a minimum, so that percent coefficient of variation (% CV) values could be determined. In at least some cases, five different diameter sample probes were used: 0.5 mm, 0.8 mm, 11.0 mm, 2.0 mm, and 3.0 mm nominal inner diameter (in general, when referring to probe sizes herein, the relevant dimension is the inner diameter). For determination of exact volumes, probe diameters and fill heights were measured by vernier calipers.

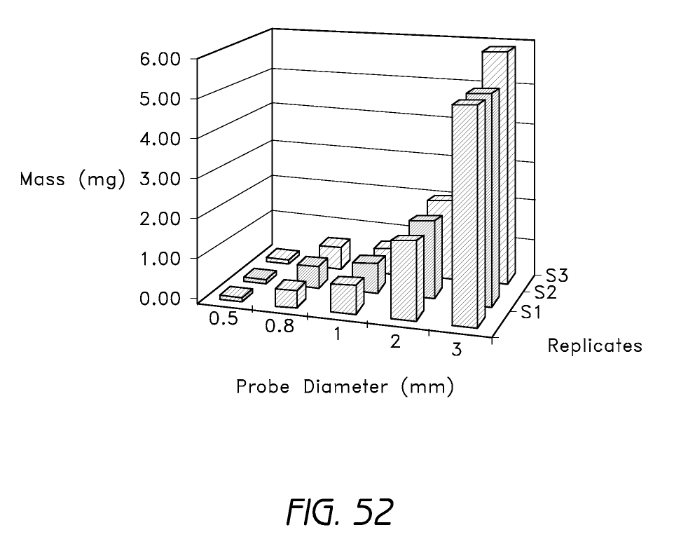

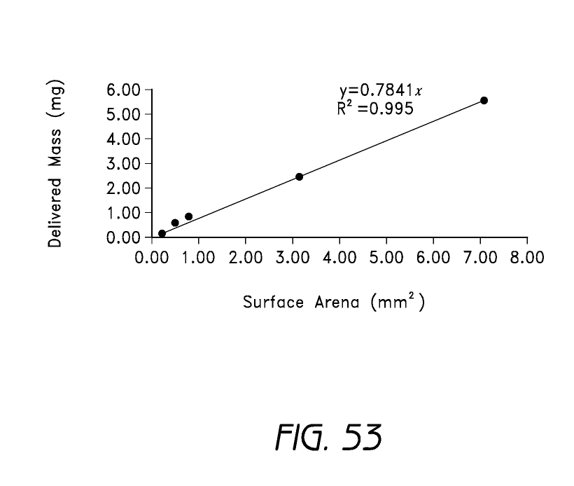

FIG. 52 shows the results of dispensing corn starch with each of the 5 different diameter sampling probes (0.5 mm, 0.8 mm, 1.0 mm, 2.0 mm, and 3.0 mm nominal inner diameter) at the same nominal fill height. For calculations, actual fill heights and diameters as measured with vernier calipers, were used. These results demonstrate the ability to deliver from an average of about 0.14 to 5.49 milligrams (mg) of powder using embodiments of the powder sampling and dispensing systems and methods taught or suggested herein. For the 15 measurements made here the average % CV in delivered mass was 8.8%. As discussed further below, these average masses do not necessarily represent the absolute mass limits of the technology, but in general, and in accordance with certain embodiments, they do cover the practical mass range that could be delivered on a discrete dispense basis. The data in FIG. 52 was regressed with a squared function to determine the goodness of fit to the theoretical dependence on cross-sectional area (i.e. radius squared). The regression line is shown in FIG. 53 and advantageously highlights the accuracy of the powder handling embodiments disclosed herein

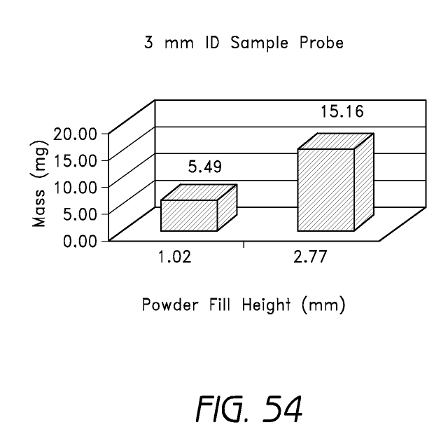

In addition to being able to deliver different volumes/masses by changing sample probe diameters, changes in probe fill height can be made. FIG. 54 shows the results of dispensing corn starch by changing fill heights with a 3 mm diameter sample probe.

As can be seen in connection with FIG. 54, a change of fill height from 1.02 mm to 2.7 7 mm, a 2.72-fold change, yields a mass increase from 5.49 mg to 15.16 mg, a corresponding 2.73-fold increase. The data from, in particular FIGS. 52 and 54 for this case, demonstrates the ability to cover two orders of magnitude of mass range, in a discrete dispense, by varying probe diameter, probe fill height, or a combination of both. Larger masses can be dispensed by simply performing multiple dispenses at a given mass. Advantageously, with this approach, masses in the hundreds of milligram range can easily be delivered.

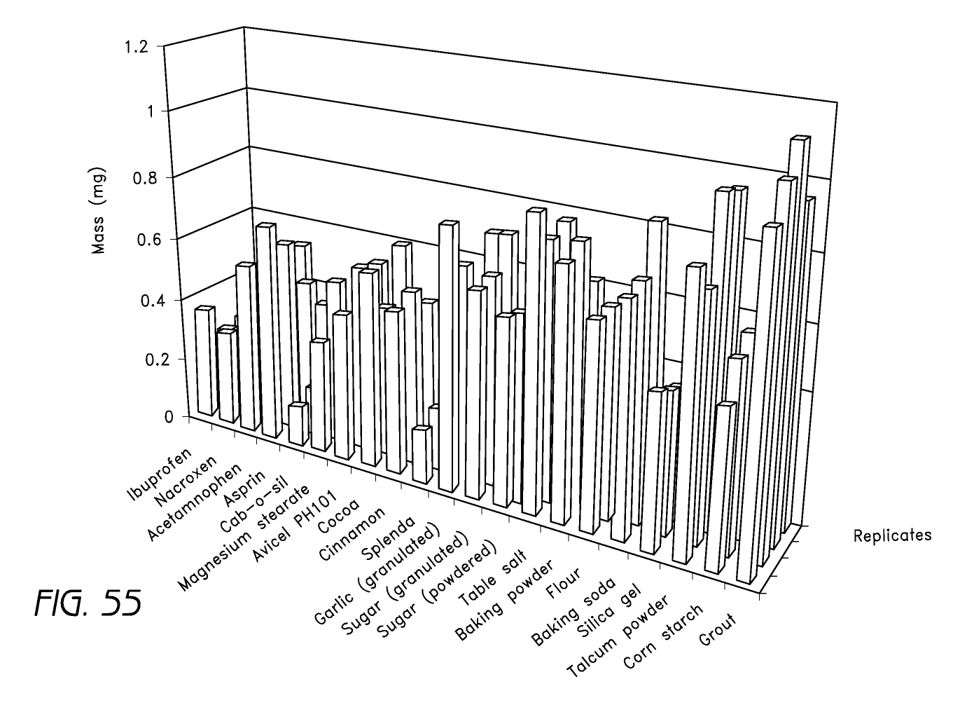

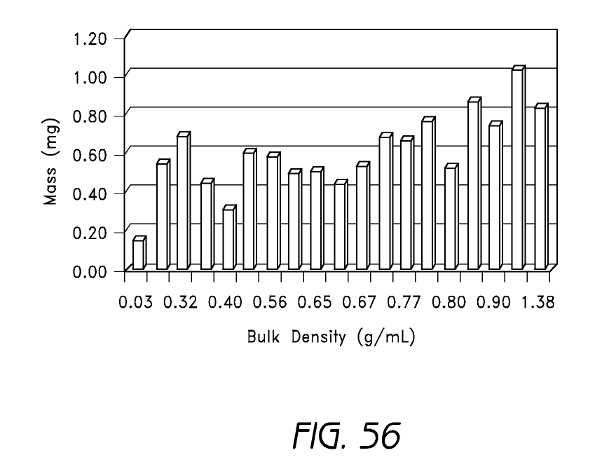

To further characterize embodiments of the powder sampling and dispensing, a panel of 20 different powders was dispensed with a 0.8 mm diameter probe, at the same nominal fill height for all powders. Each powder sample was dispensed in quadruplicate. The results of this panel of powders are shown in FIG. 55, and illustrate the accuracy and reliability achieved. [0174] The overall variability in dispensed mass was about only 12% CV across all 20 powders. It is important to note that the largest source of variability in dispensed mass, in some cases, is the variation in powder bulk density. This can be seen more definitively in FIG. 56, which shows the average delivered mass vs. powder bulk density for 19 different powders.

The data in FIGS. 55 and 56, among other, signifies that advantageously a wide range of powder bulk densities can be accommodated with the powder sampling and dispensing embodiments as taught or suggested herein. While the absolute delivered mass of a powder at a fixed sample volume generally will vary with bulk density, it is desirably possible to adjust the target volume to deliver a specific mass. This can be achieved, for example, by a simple calibration with the powder of interest, or can be approximated if the bulk density of the powder is known.

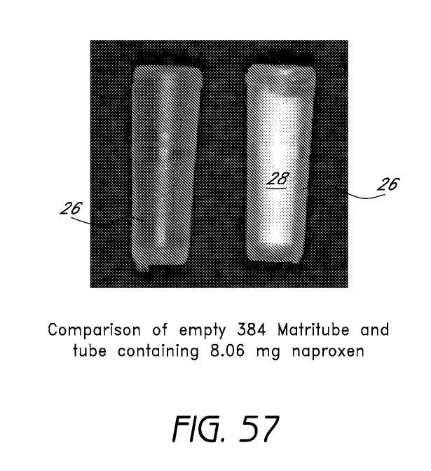

One consideration for dispensing powders is the minimum amount of sample required. This minimum amount is the amount of material that must be present in order to sample and dispense a given mass of powder. While this minimum sample amount is somewhat related to the target mass to be dispensed (in that this dictates the sample probe size, which in turn determines some minimal vessel geometry), the ideal scenario is to be able to sample from as small a starting mass as possible and to be as efficient in the use of this material as possible. FIG. 57 shows a photograph of both an empty 384 Matritube™ tube 26 and a tube 26 containing about 8.06 mg of naproxen powder material 28, and advantageously illustrates the efficacy of embodiments of the powder handling systems and methods, wherein substantially the entire powder material from a source can be sampled, and available for delivery, thereby providing, among other things, cost efficiency as related to factors such as handling of powders that may be expensive.

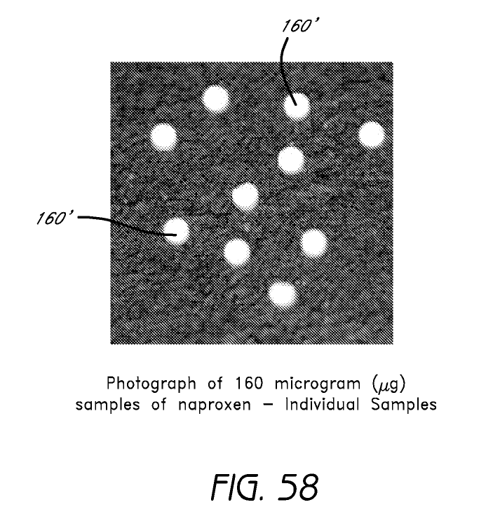

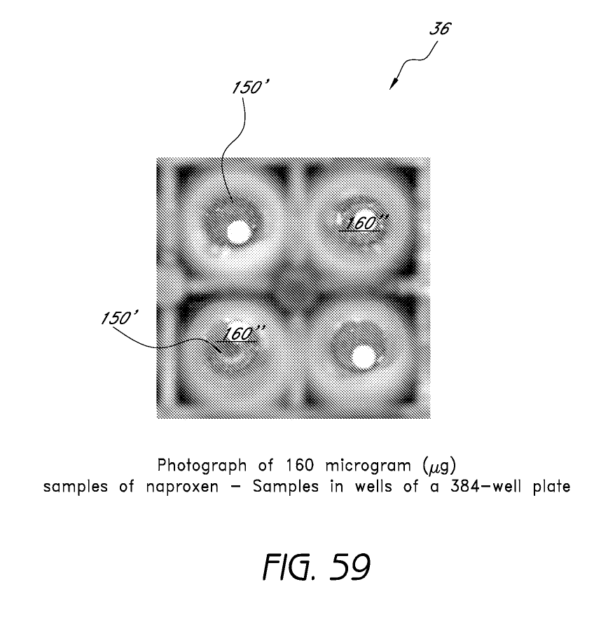

Delivering low mass samples or “doses”, particularly from these small starting masses, is also one common consideration. One typical application would involve delivering 20-50 individual samples about of 50-100 micrograms (μg) from the same sample vessel. FIGS. 58 and 59 show 160 μg doses of naproxen that have been sampled from the tube shown in FIG. 57.

FIG. 58 shows the 160 μg doses as individual samples 160′, and FIG. 59 shows the samples 160″ in wells 150′ of a 384-well plate 36. Despite the small starting mass and the very low target mass to be delivered in these applications, powder sampling and dispensing embodiments in accordance with the invention advantageously provide very reproducible results.

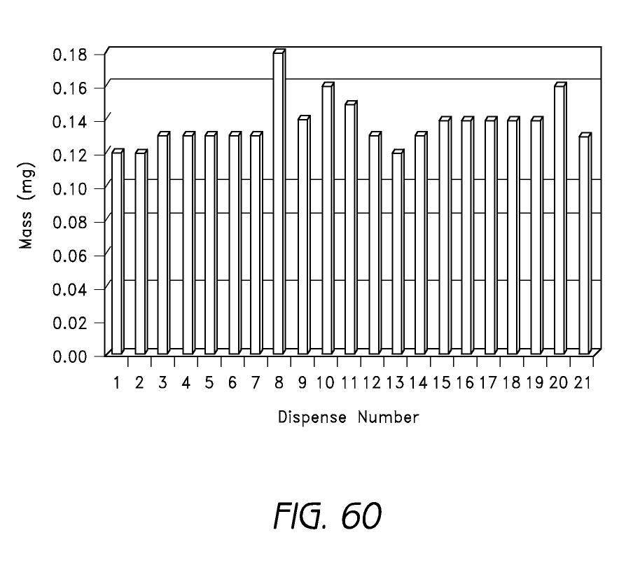

FIG. 60 shows a plot of delivered mass versus dispense number for delivery of a nominal 130 μg dose sampled from about 9.03 mg of naproxen (in the same tube as shown in FIG. 57). Desirably, for the data shown in FIG. 60, the average delivered mass was about 140 μg and this mass was delivered with an accuracy of about 11% CV.

Another consideration in powder dispensing applications is the efficiency of use of the starting mass of powder. Ideally 100% utilization of the material provided is desirable. Due to practical considerations, this is hard to achieve. However, given the ability to recover and re-use sample from starting vessels, embodiments of the powder sampling and dispensing disclosed advantageously provide extremely high efficiency in terms of utilization of starting material. TABLE 1 below shows some results that are typically obtained.

TABLE 1
Some Powder Dispensing Statistics

| | |
|---|---|
| Starting mass (mg) | 10.03 |
| Total delivered mass (mg) | 3.99 |
| Recovered mass (mg) | 5.17 |
| Unrecovered mass (mg) | 0.76 |
| Process waste (mg) | 0.11 |
| % Sample delivered | 40% |
| % Sample recovered | 52% |
| % Sample utilization | 91% |
| % Waste | 9% |

For the data in TABLE 1, “Total delivered mass” is the sum of the individual dispensed samples, “Recovered mass” is the amount of starting material that was able to be removed from the sample vessel, “Unrecovered mass” is the amount of material that was not able to be easily recovered (e.g. on the walls of the vessel), and “Process waste” is the amount of material that was truly wasted (i.e. not delivered to a target or recoverable). As can be seen, advantageously, greater than 90% of the initial starting mass is typically able to be utilized. The data in TABLE 1 involves, such as discussed previously, working with a relatively small starting mass. Small starting masses generally dictate sample vessels with a large surface area to volume ratio. As a result greater than normal amounts of material are “unrecovered” due to interaction with the vessel walls. In most applications, the % utilization desirably exceeds 95%, as sample vessels with less surface area to volume can be employed.

In general, DiSPo™ Powder Dispensing Technology and embodiments of the powder handling systems and methods desirably provide an automated means of delivering dry powders and solid materials for a wide variety of applications. The characterization data presented herein validates that the technology can be applied to a wide range of powders, with varying physical properties. In several cases, with simple calibration, target masses can be delivered, in some embodiments, in the 100 μg to 15 mg range with a an advantageous precision of 10-15% CV.

### Some Examples of “Markets” Relating to Powder Handling and Manipulation

There continues to be an increase in demand for the discovery, development and optimization of new materials. These new materials cover the range from polymers, adhesives, and pharmaceuticals all the way to catalysts, phosphors and semiconductors. Through the advances championed by the pharmaceutical industry there now exists an automation infrastructure base that can support research in new materials at a basic level. In particular, many of the automation solutions developed for combinatorial chemistry and high throughput screening have been adapted to work with the broader array of reagents and compounds encountered in non-pharmaceutical applications. The combinatorial approach is ideally used in applications where interactions beyond simple 1 and 2 components are to be studied (e.g. ternary and quaternary mixtures). In many advanced materials discovery applications it is not uncommon to conduct experiments with 5 component mixtures (and greater). To the extent that these complex combinatorial experiments have been carried out in a micro-scale, with corresponding small material budgets, screening of conditions previously unthought-of have proven extremely valuable.

Synthesis of New Materials: As advances in material property determination have been made, a renewed focus on creating materials and mixtures has begun. Depending on the nature of the material to be synthesized, a variety of techniques to create materials can be employed. Many of these approaches involve combinatorial methods, where complex multi-component mixtures are required in order to explore non-obvious “chemical space”. There have been advancements in liquid handling techniques, particularly inkjet-based approaches, resulting in the ability to explore synthesis approaches in the nanoliter to microliter regime. In addition to synthesis new materials themselves, there is a great deal of interest in changing the local environment (chemical, spatial, thermal, etc.) that a material exists in to explore and possibly exploit unique properties.

Optimization of Material Properties: Once a new material has been made it is often necessary or desirable to optimize its properties based on some measure of performance or critical property. There are many properties that are of interest, including mechanical, thermal, electrical, chemical, optical, morphological and magnetic. Based on measurement of the properties of interest, optimization of the material or its components occurs; iteration of syntheses and measurement continues until the final desired properties are achieved. Depending on the nature of the material these optimization experiments can involve either manipulating the material itself or its surrounding environment. Because many materials are costly to synthesize or produce, performing optimization experiments with minimal sample consumption is often desired. Optimization experiments in the nanoliter to microliter volume range and microgram to milligram mass range are quite common.

### Pharmaceutical Development

Polymorph Screening: A number of currently marketed pharmaceutical products have more than one crystalline form. A compound that exists in more than one crystalline form is considered to be polymorphic. While polymorphs are the same in terms of chemical composition, their physicochemical properties can very significantly. These differing physicochemical properties can dramatically affect a compounds efficacy due to changes in properties such as dissolution rate, solubility and bioavailability. Knowing this, pharmaceutical companies are moving toward more structured polymorph screens for new chemical entities. These screens are being performed earlier in the drug development process in order to maximize the chances that the most stable physical form is carried forward into the clinic. Regulatory bodies now also require demonstration of polymorph identification in submissions. Lastly, polymorph screening of compounds in late development is often valuable in terms of maximizing the intellectual property investment a pharmaceutical company has made, and offers opportunities to extend a patent portfolio.

Polymorph screening involves re-crystallizing a compound from a variety of organic solvents while often varying environmental conditions, such as rate of cooling, solution concentration (i.e. extent of supersaturation), rate of stirring (or absence of stirring), etc. Depending on the specific approach taken, and the amount of compound available for a screen, anywhere from 10's to 1000's of unique combinatorial conditions are created and analyzed for the resulting polymorphic form.

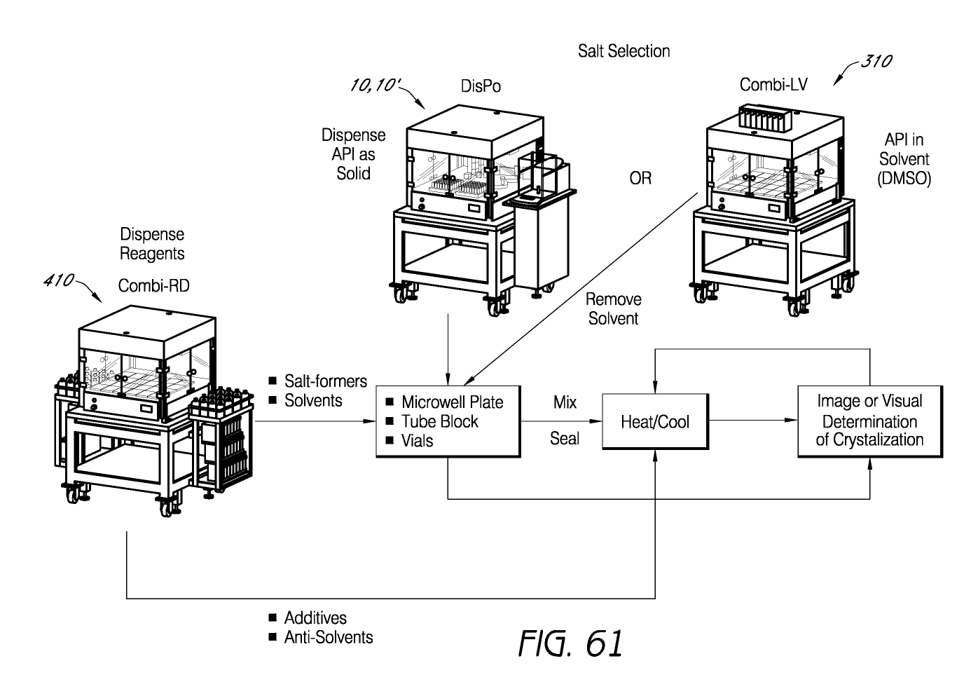

FIGS. 61-65 are respective schematic views of certain processes or methods involving: (i) salt selection; (ii) compatibility experiments; (iii, iv) solubility experiments; and (v) dosing studies having efficacy with certain embodiments of the invention. These figures illustrate the use of a powder handling system 10, 10′ (DiSPo™ Solid Dispensing System), a low volume liquid handling system 310 (Combi-RD-LV™ Reagent Dispenser), and a liquid handling system 410 (Combi-RD™ Reagent Dispenser).

Some embodiments of the system 410 are available from Entevis Inc. of Sudbury, Mass., U.S.A. In some embodiments, the reagent dispenser 410 has been specially designed to work with the most challenging of reagents and fluids. Applications involving highly viscous reagents, dispensed in a non-contact combinatorial fashion, are readily served by the dispensing system 410. An example of this type of application would be pharmaceutical pre-formulation studies (some examples of which are discussed herein). The base system is configurable from a single syringe pump, up to as many as 96 individually controllable syringe pumps. The typical non-contact dispense volume range for the dispensing system 410, in some embodiments, is between about 2 microliters (μL) and about 5 milliliters (mL), depending on the specific properties of the reagents being dispensed (e.g., viscosity). The system 410 typically delivers these volumes to within 2% of the target volume with a reproducibility within 5% Relative Standard Deviation (RSD). There are optional heated fluid lines in order to extend the reagent dispensing range (e.g., decrease the effective reagent viscosity).

Some key benefits of the system 410 include, without limitation: ability to dispense a wide variety of fluids such as highly viscous fluids (viscosities up to ˜3000 cp), organic solvents, strong acids and bases; multi-channel configuration for combinatorial applications; flow-through dispense and aspirate/dispense modes (rheology dependent); and non-contact dispense mode for rapid dispensing with minimal carryover.

When dealing with lower liquid volumes, in some embodiments, to dispense liquid or reagent drops down to the nanoliter, and in some cases in the picoliter, range a technology and product base as available from BioDot, Inc. of Irvine, Calif., U.S.A. is utilized to deliver liquids or reagents. In brief, the BioDot dispensing (and/or aspirating) system in accordance with some embodiments, comprises a positive displacement syringe pump or device (or a direct current fluid source) hydraulically coupled or in fluid communication with a solenoid dispenser or actuator, and motion control means or device(s) to provide relative motion between the dispensing/aspirating tip and the target(s)/source(s), as needed or desired. In some embodiments, the low volume liquid handling system 310 comprises any one of these BioDot systems.

BioDot's U.S. Pat. Nos. 5,738,728, 5,741,554, 5,743,960, 5,916,524, 6,537,505 B1, 6,576,295 B2, RE38,281 E, U.S. Patent Application Publication Nos. US 2003/0211620 A1, US 2004/0072364 A1, US 2004/0072365 A1, US 2004/0219688 A1, US 2005/0056713 A1, US 2006/0211132 A1, and European Patent No. EP 1 485 204 B1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application. In some embodiments, the low volume liquid handling system 310 comprises any one of the systems disclosed in the above-mentioned patent documents.

U.S. Pat. Nos. 6,063,339, 6,551,557 B1, 6,589,791 B1, and U.S. Patent Application Publication Nos. US 2002/0064482 A1, US 2003/0207464 A1, US 2003/0215957 A1, US 2003/0228241 A1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application. In some embodiments, the low volume liquid handling system 310 comprises any one of the systems disclosed in the above-mentioned patent documents.

Salt Selection (FIG. 61): A significant number of current therapeutics are delivered as salt forms (as opposed to the free base form). There are some estimates that place the percentage of salt-form medicines as high as 50%. Increasingly, pharmaceutical companies desire to conduct salt selection screening earlier in the drug development process in order to maximize their understanding of the chemical “landscape” for a given molecular entity. Because critical physico-chemical properties are heavily influenced by the salt form of a compound (e.g. melting point, morphology, hygroscopicity, powder flowability, etc.) establishing the knowledge of how the salt form performs in a drug product is critical in taking the best form of a compound into the clinic.

Typical salt selection screens involve re-crystallizing a particular compound from a variety of counter-ion solutions, as well as varying crystallization solvents and conditions. Depending on the specific approach taken, and the amount of compound available for a screen, anywhere from 10's to 1000's of unique combinatorial conditions are created and analyzed for the resulting salt form.

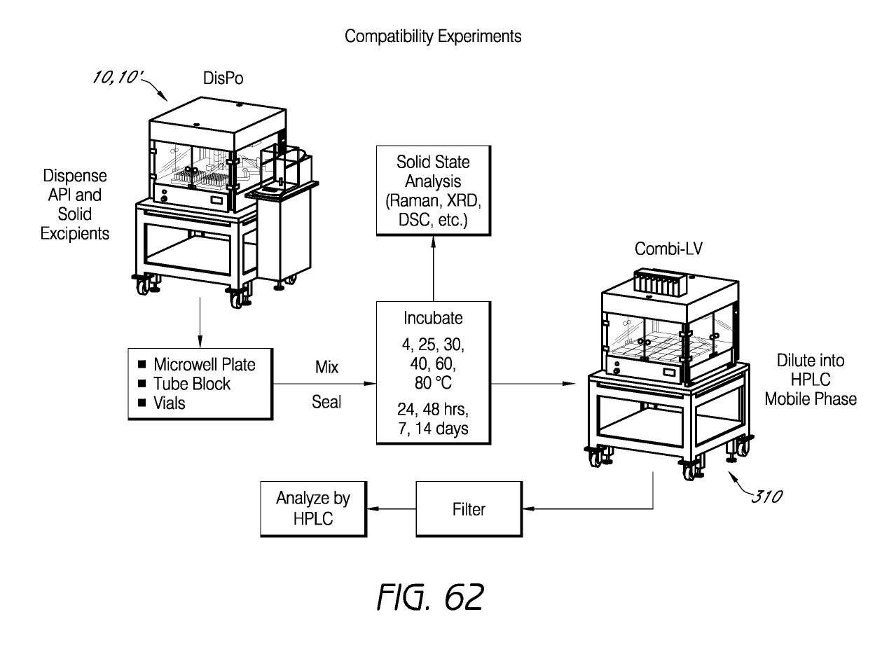

Compatibility Experiments (FIG. 62): In formulating a drug product there are many ingredients, or excipients, that are needed in addition to the drug substance itself. Of ten times there are incompatibilities between the drug substance and these excipients that lead to degradation and stability problems. Compatibility experiments involve adding the drug substance to the various excipients, at a variety of levels or concentrations, and exposing these mixtures to different environmental storage conditions (e.g. moisture, elevated temperature, etc). After mixing and exposure the amount of drug substance is determined (typically by HPLC—High Performance/Pressure/Purity Liquid Chromatography); any degradation indicates an incompatibility between the drug substance and the particular excipient(s). While these experiments can be conducted in the solution phase, the preferred experiment involves dealing with solid drug substance and neat excipients (either solid or liquid depending on the particular excipient).

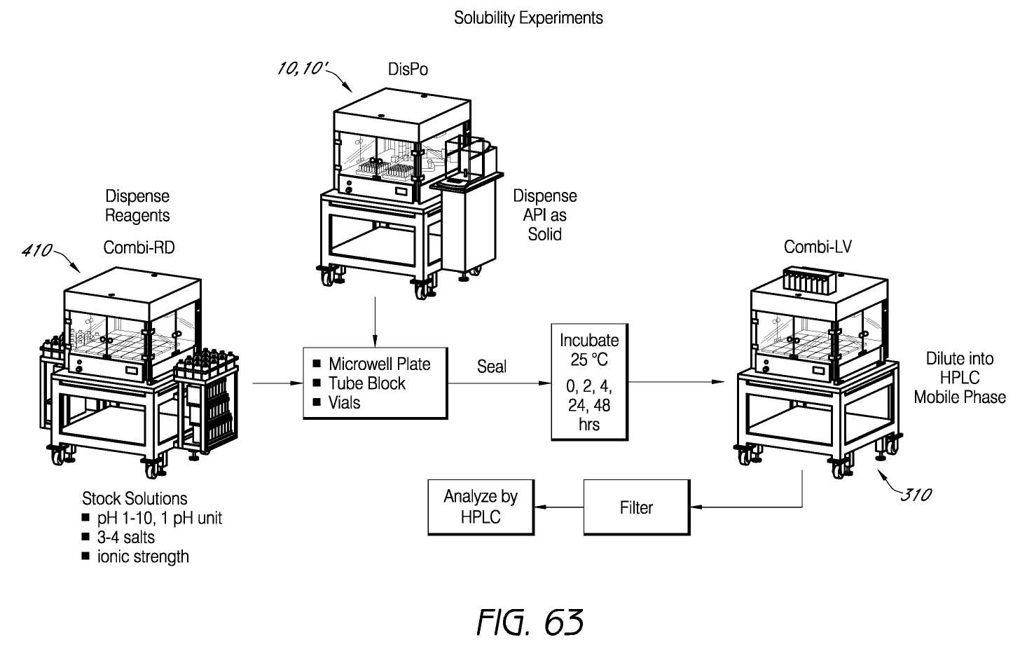

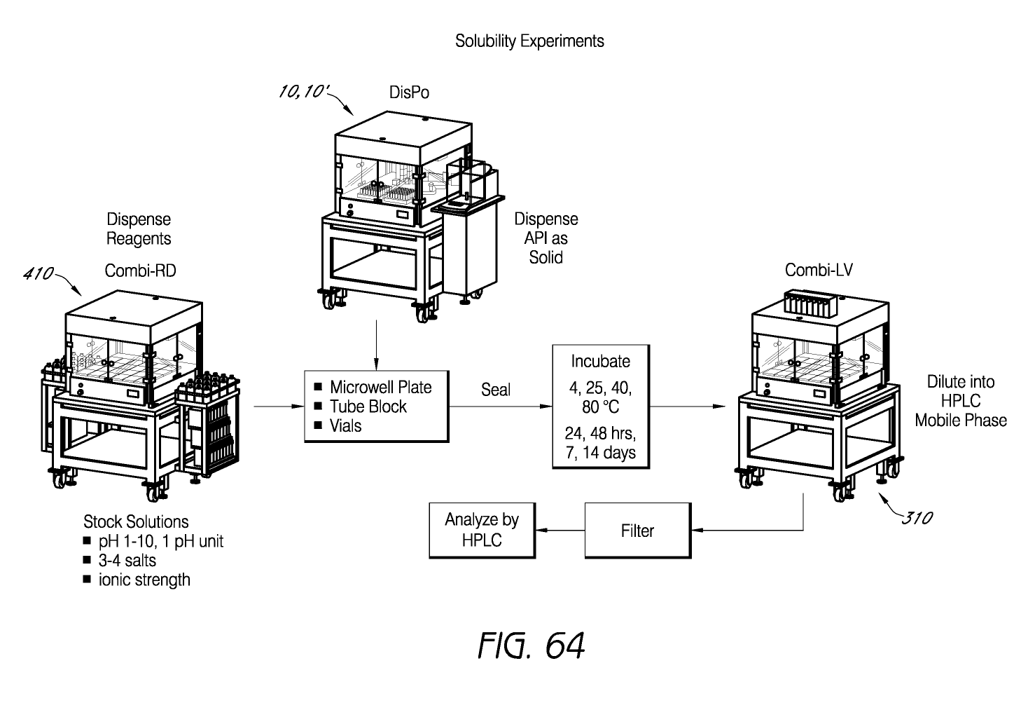

Solubility Experiments (FIGS. 63 and 64): A critical factor in developing a drug product is the chemical entities solubility in aqueous solution. Aqueous solubility is often measured in a variety of solutions that range in composition from low pH to high pH, or low ionic strength to high ionic strength. These experiments consist of adding a compound to a range of buffers, in a range of concentrations, and measuring the solubility of the compound (by UV absorbance, nephelometry or HPLC). The most desired way to carry out these experiments is to deliver the compound as a solid, so that the inherent solubility can be determined. However, due to the difficulty of delivering very small amounts of a variety of solid samples, most experiments are carried out by first dissolving the compound in a suitable solvent and then delivering as small a volume of liquid sample as possible to the buffer solutions. By minimizing the sample volume containing the compound one can minimize the enhanced solubility that the solvent gives the compound.

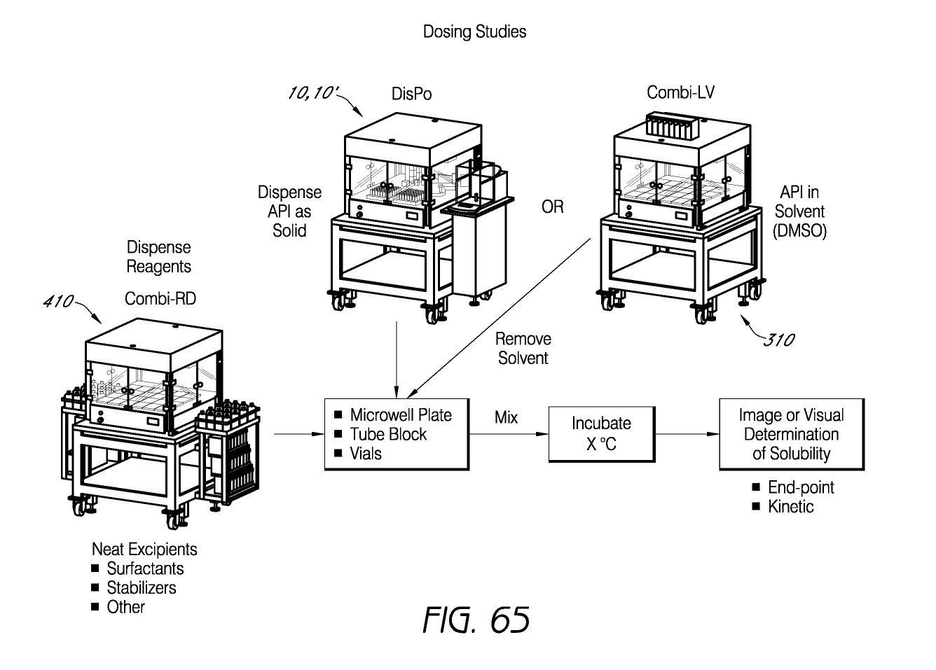

Dosing Studies (FIG. 65): Most animal dosing studies typically involve dosing compounds in suspensions. This is because there is often not a feasible or viable solution-based vehicle suitable for dosing. As a result there can be a discrepancy between the bioavailability measured in an animal dosing study and the inherent potential of a compound due to the dosing vehicle that is used. Dosing with solution-based vehicles (both aqueous and non-aqueous) allows for more accurate prediction of bioavailability and therefore provides a better chance to maximize the potential of a particular compound.

Dosing screens are typically conducted by creating a range of vehicles from both aqueous and non-aqueous excipients. These mixtures can be created through combinatorial means, or can be made up as simple ratios of ingredients. A common strategy is to create a “library” of vehicles and use this library as a screen for all compounds. Alternatively, a unique set of vehicles can be created for a particular compound based on the specific chemistry or functionality of the compound of interest. Once the compound has been added to the range of vehicles selection of the most suitable formulation is based on determining or estimating the compounds solubility in the vehicle. This can be accomplished either by quantitative measurement (e.g. HPLC) or by visual inspection for solubility (i.e. presence of un-dissolved compound or precipitation).

### Some Liquid and Reagent Handling Embodiments

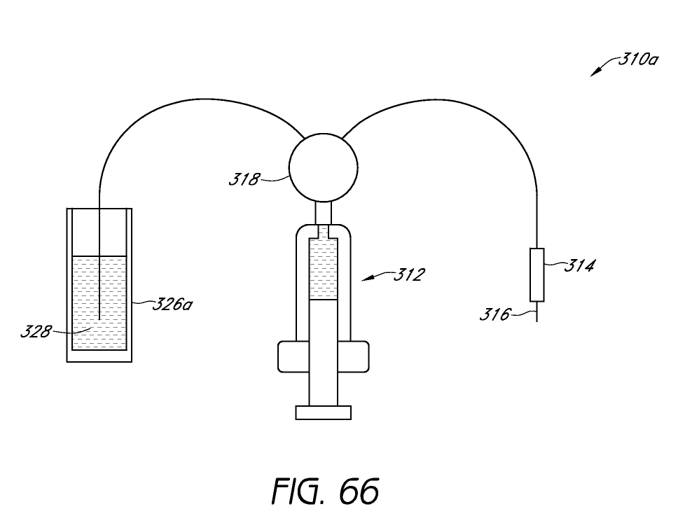

FIGS. 66 to 68 show certain embodiments of liquid handling systems 310 (310a, 310b) for low volume reagent aspirating and dispensing applications. In some embodiments, the systems 310 (310a, 310b) have been designed around BioDot's patented BioJet Plus technology (see www.biodot.com for more information on BioDot products). This technology brings low volume (i.e. nanoliter and picoliter range) non-contact liquid handling capabilities for use in conjunction with the powder handling systems disclosed herein. The BioJet Plus technology, in some embodiments, involves the combined use of a high resolution syringe pump that is precisely controlled and synchronized with a high speed drop-on-demand solenoid inkjet valve. Applications involving complex reagent mixtures, dispensed in a non-contact combinatorial fashion, are readily served by the systems 310 (310a, 310b). The non-contact dispense mode allows dispensing onto and into a wide variety of substrates. With the CX valve (e.g., as available from HOERBIGER of Switzerland, among others) option, a wide range of organic solvents can be handled with complete chemical compatibility. This can be particularly important in combinatorial materials discovery studies. The system 310 is also capable of operating in an aspiration mode in addition to bulk dispensing. This means that experiments can be conducted with as little as 10's of microliters or less of reagent. In some embodiments, the base system is configurable from a single BioJet Plus channel, up to as many as 96 individually controllable channels. There are optional heated fluid lines in order to extend the reagent dispensing range. The typical non-contact dispense volume range for the systems 310 (310a, 310b) is between, in one embodiment, 10 nanoliters (nL) and 5 μL, and in another embodiment, 1 mL or less and 1 μL, depending on the specific properties of the reagents being dispensed. The systems 310 (310a, 310b), in some embodiments, deliver these volumes to within 5% of the target volume with a reproducibility within 10% RSD for volumes less than about 100 mL and 5% for volumes greater than about 100 mL.

Some key benefits of the systems 310 (310a, 310b) include, without limitation: nanoliter and picoliter, non-contact dispensing allows low volume dispensing (e.g., supports advanced materials research programs), can be used in conjunction with multiple dispense modes (e.g., discrete drops and bursts of drops), and can create a variety of dispense patterns (e.g., drops, lines, and dashes, among others); multi-channel configuration for combinatorial applications, among others, flow-through dispense and aspirate/dispense modes (rheology dependent); several platform sizes and configurations to choose from; can be efficaciously combined with the reagent handling capabilities of the system 410.

Referring in particular to FIG. 66, in some embodiments, the system 310a generally comprises a stepper motor driven syringe or pump 312, in selective fluid communication with a micro solenoid valve 314 and a nozzle 316 via a switching valve 318. The syringe or pump 312 is also in selective fluid communication with, via the switching nozzle 318, a reservoir 326a containing a liquid or reagent 328 to be dispensed.

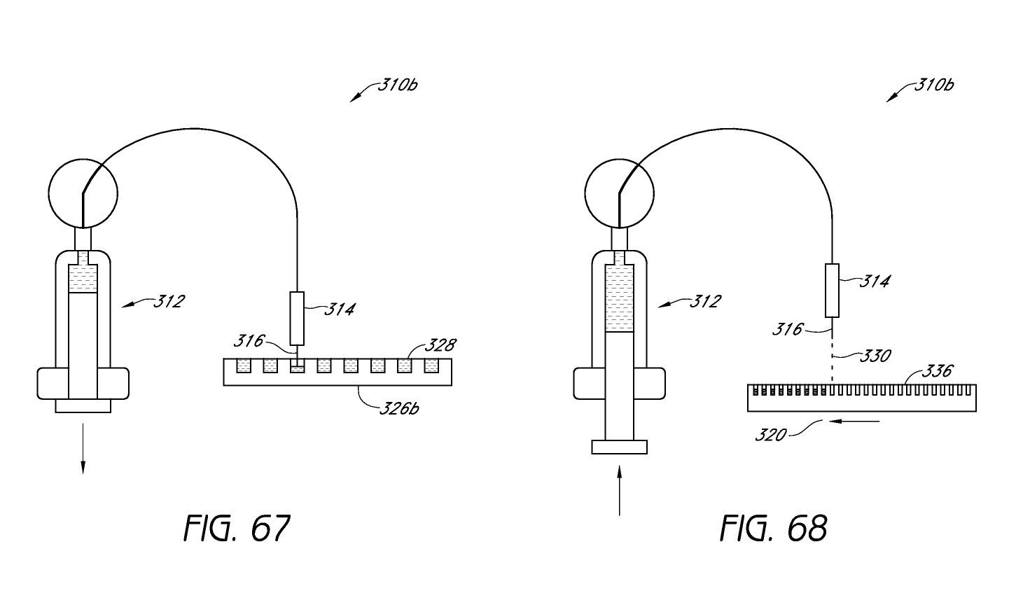

FIGS. 67 and 68 show certain embodiments of aspirate and dispense mode utilizing some embodiments of the system 310b. Sample 328 (from the source 326) is first aspirated into the fluid path by retracting the syringe 312 while the dispense nozzle 316 is submerged in the sample 328 of interest. After introducing or aspirating the liquid or reagent sample, the dispensing occurs via bulk dispensing in the form of one or more drops or droplets 330 of the liquid reagent 328 into or onto a target 336. Motion control can be provided by one or more robotic arms, tables or carriages such as the XY translation stage 320.

The methods which are described and illustrated herein are not limited to the sequence of acts described, nor are they necessarily limited to the practice of all of the acts set forth. Other sequences of acts, or less than all of the acts, or simultaneous occurrence of the acts, may be utilized in practicing embodiments of the invention.

It is to be understood that any range of values disclosed, taught or suggested herein comprises all values and sub-ranges therebetween. For example, a range from 5 to 10 will comprise all numerical values between 5 and 10 and all sub-ranges between 5 and 10.

From the foregoing description, it will be appreciated that a novel approach for powder sampling, dispensing and/or handling has been disclosed. While the components, techniques and aspects of the invention have been described with a certain degree of particularity, it is manifest that many changes may be made in the specific designs, constructions and methodology herein above described without departing from the spirit and scope of this disclosure.

While a number of preferred embodiments of the invention and variations thereof have been described in detail, other modifications and methods of using and other materials discovery, development and optimization, and life sciences, biotech, pharmaceutical, diagnostic, medical, chemical, biological and/or agricultural applications for the same will be apparent to those of skill in the art. Accordingly, it should be understood that various applications, modifications, and substitutions may be made of equivalents without departing from the spirit of the invention or the scope of the claims.

Various modifications and applications of the invention may occur to those who are skilled in the art, without departing from the true spirit or scope of the invention. It should be understood that the invention is not limited to the embodiments set forth herein for purposes of exemplification, but is to be defined only by a fair reading of the claims, including the full range of equivalency to which each element thereof is entitled.

What is claimed is:

1. A powder handling system, comprising:
a dispense head comprising at least one channel for sampling and delivering a powder;
said channel comprising a probe that is at least partially insertable into a powder source to sample a predetermined amount of said powder and dispense said predetermined amount of said powder into or onto a target; and
said dispense head being configured such that it can be selectively operated such that said probe has the ability to pick up said powder in either a constant displacement mode with a known powder depth or a constant pressure mode which is substantially independent of powder height.

2. The system of claim 1, wherein said dispense head is moveable by a pneumatic or motor driven actuator.

3. The system of claim 1, wherein said probe comprises a moveable plunger housed within an outer tube.

4. The system of claim 1, wherein said powder source comprises a vial which is positioned in a holder assembly which comprises a vibration device that facilitates in settling the powder in said vial after a sampling operation.

5. The system of claim 4, wherein said holder assembly further comprises a flexible stripper plate that facilitates in removal of any powder that may adhere to the probe outer surface during a sampling operation.

6. The system of claim 1, wherein said probe is displaceable in a shearing, motion to facilitate removal of any excess powder extruding from a distal orifice of the probe.

7. The system of claim 1, wherein said probe size is selectable from a range of different probe sizes.

8. The system of claim 1, wherein said system comprises a reflective sensor.

9. The system of claim 1, wherein said system comprises a proximity sensor.

10. The system of claim 1, wherein said system comprises a controller.

11. The system of claim 1, wherein said system comprises a motion control system.

12. The system of claim 1, wherein said system can sample from a powder source containing as low as 1 milligram or less of said powder.

13. The system of claim 1, wherein said system can dispense powder in the microgram range.

14. The system of claim 1, wherein said powder comprises particles having a size in the range from about 5 microns (μm) to about 10 microns (μm).

15. The system of claim 1, wherein said powder comprises particles having a size in the range from about 100 microns (μm) to about 150 microns (μm).

16. A method of handling a powder, comprising
inserting a probe in a source containing a powder to be sampled and delivered to a target;
selecting between two modes of powder sampling;
wherein a first mode of said two modes comprises picking up said powder in a constant displacement mode with a known powder depth;
wherein a second mode of said two modes comprises picking up said powder in a constant pressure mode which is substantially independent of powder height; and
sampling a predetermined amount of said powder by one of said first or second modes and delivering a predetermined quantity of said powder to said target.

17. The method of claim 16, wherein said method further comprises using a plunger of said probe to compress said powder prior to said sampling of said powder.

18. The method of claim 17, wherein said method further comprises measuring the compression force exerted by said plunger.

19. The method of claim 18, wherein said compression force is measured by a force or pressure sensor.

20. The method of claim 16, wherein delivering a predetermined quantity of said powder to said target comprises pneumatically dispensing said powder.

21. The method of claim 16, wherein delivering a predetermined quantity of said powder to said target comprises dispensing said powder using a motorized actuator.

22. The method of claim 16, wherein said predetermined amount and said predetermined quantity are substantially the same.

23. The method of claim 16, wherein said predetermined amount is greater than said predetermined quantity.

24. The method of claim 16, wherein said method further comprises measuring the mass of said powder delivered to said target.

25. The method of claim 24, wherein said measuring the mass of said powder comprises using a mass balance or load cell to perform the mass measurement.

26. The method of claim 16, wherein the mass of said powder in said source is in the range from about 5 milligrams (mg) to about 50 milligrams (mg).

27. The method of claim 16, wherein the mass of said powder delivered to said target is in the range from about 100 micrograms (μg) milligrams to about 20 milligrams (mg).
